(19) United States
(12) Patent Application Publication
(10) Pub. No.: US 2007/0064886 A1
(43) Pub. Date: Mar. 22, 2007

(54) Methods, systems, and computer program products for dynamically controlling a PSTN network element from an IP network element using signaling

(75) Inventors: Phil Chiu, Plano, TX (US); Mahesh Tomar, Morrisville, NC (US); Vikram Nair, New Delhi (IN); Arvind Kumar Gupta, New Delhi (IN); Shelja Bhatia, Gurgoan (IN); Pradeep Kumar, Delhi (IN)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/512,716

(22) Filed: Aug. 28, 2006

Related U.S. Application Data
(60) Provisional application No. 60/712,032, filed on Aug. 26, 2005.

(51) Int. Cl. H04M 1/64

(52) U.S. Cl. 379/88.17

(57) ABSTRACT

Methods, systems, and computer program products for dynamically controlling a PSTN network element from an IP network element using signaling are disclosed. According to one aspect, a method may include receiving a first SIP message from an IP application server. The first SIP message may identify a call event trigger associated with a subscriber to a circuit switched network. In response to receiving the first SIP message, a first SS7 message identifying the call event trigger and the subscriber may be generated and routed to a circuit switched network node. A second SS7 message may be received that indicates triggering of the call event corresponding to the trigger. A second SIP message indicating the call event may be routed to the IP application server. A third SIP message may be received that specifies a PSTN call control function.

### CROSS-REFERENCE TO RELATED APPLICATION

This application claims the benefit of U.S. Provisional Patent Application Ser. No. 60/712,032 filed Aug. 26, 2005, the disclosure of which is incorporated by reference herein in its entirety.

### TECHNICAL FIELD

The subject matter described herein relates to methods, systems, and computer program products for providing packet network-based communication services. More particularly, the subject matter described herein relates to methods, systems, and computer program products for dynamically controlling a PSTN network element from an IP network element using signaling.

### BACKGROUND

In telecommunications networks, it is becoming increasingly desirable to provide services to subscribers via an IP network, due to the reduced cost of IP networking equipment relative to the corresponding circuit switched equipment. Examples of services that it may be desirable to provide include Internet call waiting, call forwarding, caller ID delivery, or other services. Providing each of these services using IP equipment requires notification of PSTN events, such as call termination attempts.

In order to address some of the issues associated with providing services using IP equipment, IETF RFC 3910, entitled the SPIRITS (services in the PSTN requesting Internet services) protocol, draft-IETF-SPIRITS-protocol-04.txt, Feb. 2003, the disclosure of which is incorporated herein by reference in its entirety, specifies methods by which a SPIRITS server can subscribe and receive notification of events in the PSTN. For example, for the Internet caller ID delivery service, where a subscriber connected to the Internet via a dial-up connection receives the identification of a caller, the SPIRITS protocol presents a call flow for providing the service. In the call flow, a SPIRITS server subscribes to receive notification from a SPIRITS client of an incoming call attempt. A termination attempt trigger must be set at the called party's end office to detect calls to the called party. When a trigger is detected, the end office notifies the SPIRITS client, which notifies the SPIRITS server of the termination attempt. The notification from the SPIRITS client will include the caller ID.

While the SPIRITS protocol specifies call flows for providing simple services, such as Internet caller ID and call waiting, the SPIRITS protocol fails to completely specify how to perform services that require ongoing participation of PSTN entities, such as end offices. The SPIRITS protocol also lacks many advanced intelligent network (AIN) messages that are available in the PSTN. Another shortcoming of the SPIRITS protocol is that it fails to include a method for sending unsolicited messages to AIN nodes for calls requiring dynamic treatment. The examples in the SPIRITS protocol relate to delivering event notifications to the SPIRITS server in response to PSTN events.

One example of a service that requires dynamic treatment is dynamic redirection of a call from one phone to another phone using an IP interface. For example, it may be desirable for a caller to receive notification via his or her computer terminal at work of calls that the caller receives at home. When the caller receives a call to his or her home telephone number, a window may appear on the caller's computer terminal at work indicating that his or her home phone is ringing. If no one answers the call within a few seconds, it may be desirable for the user to redirect the call to his or her work phone or cell phone. The SPIRITS protocol provides methods for the user to receive notification of the call but not to dynamically redirect the call to another phone.

Some dynamic services are available. For example, the Verizon iobi service allows users to receive notification of incoming calls via a computer interface and either answer the call or forward the call to voicemail. However, none of the examples available on the Verizon iobi website (http://www.22.verizon.com/business/iobi/) disclose dynamic call redirection to a location other than voicemail. In general, it is believed that there is no available mechanism for an IP application server to dynamically control a PSTN network element to provide dynamic call treatment.

Accordingly, there exists a need for methods, systems, and computer program products for dynamically controlling a PSTN network element from an IP network element using signaling.

### SUMMARY

According to one aspect, the subject matter described herein includes a method for dynamically controlling a PSTN network element from an IP network element using signaling. The method includes receiving a first SIP message from an IP application server. The first SIP message may identify a call event trigger associated with a subscriber to a circuit switched network. A first SS7 message identifying the call event trigger and the subscriber may be generated in response to receiving the first SIP message. The first SS7 message may be routed to a circuit switched network node. A second SS7 message may be received from the circuit switched network node. The second SS7 message may indicate triggering of the call event corresponding to the trigger. A second SIP message indicating triggering of the call event may be generated and routed to the IP application server in response to receiving the second SS7 message. A third SIP message may be received in response to the second SIP message. The third SIP message may specify a PSTN call control function.

According to another aspect, the subject matter described herein may provide for specifying that a call be established between phones. One exemplary method for specifying such a call may include receiving a first SIP message from an IP application server. The first SIP message may specify to establish a call between phones. At least one of the phones may be associated with a subscriber to a circuit switched network. In response to receiving the first SIP message, a first SS7 message may be generated that specifies that the call be established between the phones. The first SS7 message may be routed to a circuit switched network node.

According to another aspect, the subject matter described herein may provide information for use during resumed call setup processing. One exemplary method may include receiving a request by a calling party to communicate with a called party at circuit switched network node. In response to receiving the request, call setup processing may be suspended and a TCAP request message generated which is routed to a SIP-SS7 gateway. The TCAP request message may be received at the SIP-SS7 gateway. The SIP-SS7 gateway may generate a related SIP request message. The SIP request message may be communicated to a VoIP application server function. A call control function may be performed and an associated SIP response message generated at the VoIP application server function. The SIP response message may be routed to the SIP-SS7 gateway. At the SIP-SS7 gateway, the SIP response message may be received and a related TCAP response message generated. The TCAP message may be routed to the circuit switched network node. The TCAP response message may be received at the circuit switched network node. The circuit switch network node may use information conveyed in the TCAP response message during resumed call setup processing.

The subject matter described herein can be implemented as a computer program product comprising computer executable instructions embodied in a computer readable medium. Exemplary computer readable media suitable for implementing the subject matter described herein include disk memory devices, chip memory devices, application specific integrated circuits, programmable logic devices, and downloadable electrical signals. In addition, a computer program product that implements the subject matter described herein may be located on a single device or computing platform. Alternatively, the subject matter described herein can be implemented on a computer program product that is distributed across multiple devices or computing platforms.

### BRIEF DESCRIPTION OF THE DRAWINGS

Exemplary embodiments of the subject matter will now be explained with reference to the accompanying drawings, of which:

FIG. 1 is a diagram of an example of a telecommunications system for methods, systems, and computer program products for dynamically controlling a PSTN network element from an IP network element using signaling according to an embodiment of the subject matter described herein;

FIG. 2 is a flow chart of an exemplary process for methods, systems, and computer program products for dynamically controlling a PSTN network element from an IP network element using signaling according to an embodiment of the subject matter described herein;

FIG. 3 is a diagram of an example of a telecommunications system for providing a click-to-call feature to a circuit switched network subscriber according to an embodiment of the subject matter described herein;

FIG. 4A is a diagram of an example of a telecommunications system for providing a dynamic incoming call redirect feature to a circuit switched network subscriber according to an embodiment of the subject matter described herein;

FIG. 4B is a screen display of an exemplary pop-up window for indicating an incoming call and a name and directory number associated with the call according to an embodiment of the subject matter described herein;

FIG. 5 is a diagram of an example of a telecommunications system for providing a dynamic incoming call feature to a circuit switched network subscriber wherein a calling party disconnects according to an embodiment of the subject matter described herein;

FIG. 6 is a diagram of an example of a telecommunications system for providing a find-me/simulation ring feature to a circuit switched network subscriber according to an embodiment of the subject matter described herein;

FIG. 7A is a screen display of an exemplary call log entry according to an embodiment of the subject matter described herein;

FIG. 7B is a message flow diagram illustrating an exchange of messages between a VoIP application server and a presence server for obtaining subscriber presence information according to an embodiment of the subject matter described herein;

FIG. 8 is a screen display for selecting call management features according to an embodiment of the subject matter described herein;

FIG. 9 is a diagram of an example of a telecommunications system exchanging messages in an exemplary scenario of monitoring an incoming call that is locally answered and indicating that the call was answered according to an embodiment of the subject matter described herein;

FIG. 10 is a diagram of an example of a telecommunications system exchanging messages in an exemplary scenario of monitoring an incoming call that is locally answered and indicating that the call was terminated according to an embodiment of the subject matter described herein;

FIG. 11 is a diagram of an example of a telecommunications system exchanging messages in an exemplary scenario of managing an incoming call to a subscriber phone with no call waiting and that is locally busy according to an embodiment of the subject matter described herein;

FIG. 12 is a diagram of an example of a telecommunications system exchanging messages in an exemplary scenario of forwarding an incoming call to another phone according to an embodiment of the subject matter described herein;

FIG. 13 is a diagram of an example of a telecommunications system exchanging messages in an exemplary scenario of receiving indication of an incoming call to a busy phone and managing the call according to an embodiment of the subject matter described herein;

FIG. 14 is a diagram of an example of a telecommunications system exchanging messages in an exemplary scenario of an incoming call to a busy phone according to an embodiment of the subject matter described herein;

FIG. 15 is a diagram of an example of a telecommunications system exchanging messages in an exemplary scenario of providing no action to an incoming call according to an embodiment of the subject matter described herein;

FIG. 16 is a diagram of an example of a telecommunications system exchanging messages in an exemplary scenario of redirecting an incoming call to voice mail or a mobile phone according to an embodiment of the subject matter described herein;

FIG. 17 is a diagram of an example of a telecommunications system for providing a click-to-call feature according to an embodiment of the subject matter described herein;

FIG. 18 is a block diagram illustrating exemplary internal architectures of an application server and an SSG according to an embodiment of the subject matter described herein;

FIG. 19 is a diagram illustrating missed call notification according to an embodiment of the subject matter described herein;

FIG. 20 is a flow chart of an exemplary process by which a VoIP application server may provide a circuit switched network node with information for responding to a call event trigger according to an embodiment of the subject matter described herein; and

FIG. 21 is a message flow diagram of an exemplary call redirect using signals according to an embodiment of the subject matter described herein.

### DETAILED DESCRIPTION

According to one aspect, a telecommunications system for providing packet network-based communication services to circuit switched network subscribers may be implemented as hardware, software, and/or firmware components executing on one or more components of a telecommunications system. The subject matter described herein may be used for providing a circuit switched network subscriber with the ability to view call activity information associated with a remote phone. The call activity information may be provided to the subscriber via a graphical user interface (GUI). Further, the call activity may be logged.

The subject matter described herein may provide a subscriber with the ability to specify PSTN call control functions and to dynamically instruct a PSTN network element to implement the control functions. The PSTN call control functions may be specified via a GUI. The subscriber may be able to remotely control static call activity, such as send to voice mail, ignore a call, call later, and call redirect, on a call-by-call basis and time of day. Further, the subscriber may be able to dynamically route incoming calls to the remote phone. Click-to-dial functionality, simultaneous ringing, and find-me call control functions may also be provided to the subscriber. Call control functions may be specified by a subscriber at a web-enabled computer.

The subject matter described herein may also provide other advanced intelligent network (AIN) services in IP networks. Further, the subject matter described herein facilitates communication between AIN nodes and SIP nodes for hosting and defining services in the AIN domain and the SIP domain. These services may be provided to SIP and PSTN subscribers. A subscriber may control the implementation of these services at a web-enabled computer.

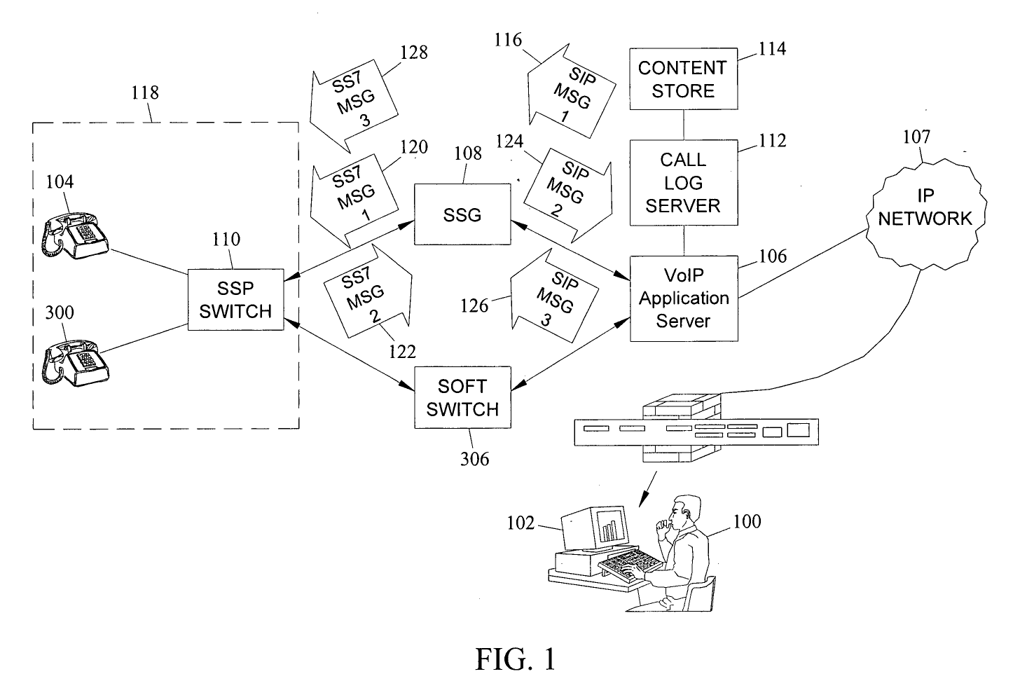

FIG. 1 illustrates an example of a telecommunications system for dynamically controlling a PSTN network element from an IP network element using signaling according to an embodiment of the subject matter described herein. Referring to FIG. 1, a subscriber 100 may access a computer 102 for viewing information related to communication services to which the subscriber subscribes and for specifying call control functions. Subscriber 100 may input instructions into computer 102 for requesting notification of a call event and/or for requesting that a call control function to be implemented in response to triggering of a call event trigger. The call event may be associated with a phone 104, which may be accessible by subscriber 100. The instructions may be communicated to VoIP application server 106 via an IP network 107. In one example, IP network 107 may be the Internet and messages are exchanged between computer 102 and application server 106 using HTTP.

VoIP application server 106 may generate and communicate a session initiation protocol (SIP) message to SIP-signaling system 7 (SS7) gateway (SSG) 108 for identifying a call event trigger associated with subscriber 100. SSG 108 may receive the SIP message from VoIP application server 106. In response to receiving the SIP message identifying the call event trigger, SSG 108 may generate and route an SS7 message identifying the call event trigger and subscriber 100 to a circuit switched network node. For example, the SS7 message identifying the call event trigger and subscriber 100 may be routed to a service switching point (SSP) 110. Exemplary call events that may trigger a call event trigger include a termination attempt or incoming call to the subscriber, an off-hook delay, an answer, a busy indication, and no answer. Further, for example, call triggering may occur based on a calling source and a time of day that the call is made.

SSP 110 may receive the SS7 message from SSG 108 and enable or arm a call event trigger for triggering on detection of the call event identified by the SS7 message. Such dynamic arming of a trigger in response to a received signaling message is not possible using the SPIRIT protocol described above. In response to triggering of the call event, SSG 108 may generate and communicate an SS7 message indicating triggering of the call event and route the SS7 message to SSG 108. Further, the SS7 message may identify the subscriber associated with the trigger.

In response to receiving the SS7 message indicating triggering of the call event, SSG 108 may generate and route a SIP message to VoIP application server 106 for indicating triggering of the call event. Further, the SIP message may indicate the subscriber associated with the trigger. In response to receiving the SIP message indicating triggering of the call event, VoIP application server 106 may generate and route a SIP message to SSG 108 for specifying a PSTN call control function. Exemplary call control functions include redirecting an incoming call and terminating an incoming call.

VoIP application server 106 may generate and communicate a SIP message for specifying the PSTN call control function. SSG 108 may generate a corresponding SS7 message for specifying the PSTN call control function and may forward the message to SSP 110. In response to receiving the SS7 message specifying the PSTN call control function, SSP 110 may perform the PSTN call control function.

VoIP application server 106 may communicate a message to computer 102 for indicating triggering of the call event. Notification of call event triggering may be viewed by subscriber 100 via computer 102. For example, computer 102 may include a display for displaying a window for notifying subscriber 100 of call event triggering.

VoIP application server 106 may generate and communicate a message to a call log server 112 for indicating triggering of the call event for subscriber 100. In response to receiving the message, call log server 112 may generate and store a record of the call event for subscriber 100 in a content store 114. Exemplary call log record information includes a directory number associated with the call event and a time of occurrence of the call event.

Further, triggering of the call event corresponding to the trigger and setting up redirection of the call to the predetermined directory number occur in real-time. This feature may be advantageous, for example, because a subscriber may be able to redirect the call to another phone in real-time before a calling party disconnects or otherwise terminates the call.

In this example, call log server 112 and content store 114 are external to VoIP application server 106. However, the subject matter described herein is not limited to such as embodiment. For example, a call log server and a content store may be integrated within a VoIP application server. In such an implementation, the VoIP application server may receive a message and, based on the message, determine a call event for a subscriber. The VoIP application server may store a record of the call event in a call log server database.

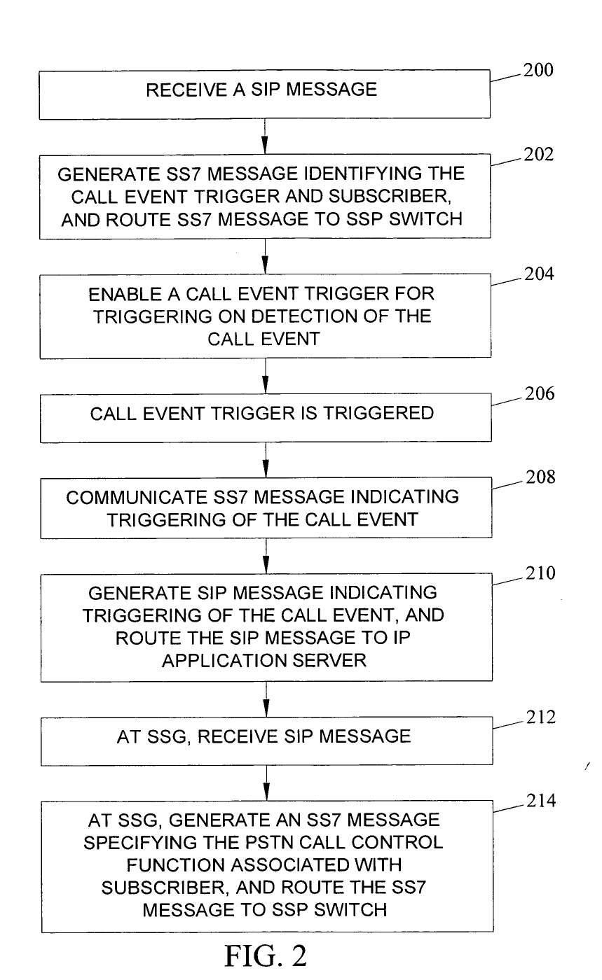

FIG. 2 is a flow chart of an exemplary process for methods, systems, and computer program products for dynamically controlling a PSTN network element from an IP network element using signaling according to an embodiment of the subject matter described herein. Referring to FIGS. 1 and 2, in block 200, SSG 108 may receive a SIP message 116 from IP application server 106. SIP message 116 may identify a call event trigger associated with subscriber 100 having a subscription to a circuit switched network 118. In response to receiving SIP message 116, SSG 108 may generate an SS7 message 120 that identifies the call event trigger and subscriber 100, and SSG 108 may route SS7 message 120 to SSP switch 110, which is a node of circuit switched network 118 (block 202). In block 204, SSP switch 110 may enable a call event trigger for triggering on detection of the call event identified by SS7 message 120. The call event trigger may be triggered (block 206). In response to triggering, SSP switch 110 may communicate a SS7 message 122 to SSG 108 for indicating triggering of the call event (block 208).

In block 210, SSG 108 may receive SS7 message 122 from SSP 110. In response to receiving SS7 message 122, SSG 108 may generate a SIP message 124 that indicates triggering of the call event, and route SIP message 124 to IP application server 106. Rather than using the Subscribe-Notify method specified by the above-referenced SPIRITs protocol, SIP message 124 may be a SIP Options message including SIP call-identifier for correlating subsequent messages. The SIP Options message is traditionally used by SIP nodes to learn the capabilities of other nodes. Rather than using the SIP Options message in this way, SSG 108 may use the message to pass event notifications received from PSTN nodes, such as SSP 110, to IP application server 106. If the Subscribe-Notify procedure of the SPIRITs protocol were used, SSG would be required to maintain a database of directory numbers and corresponding subscribed-to events. However, according to the present embodiment, SSG 108 is not required to maintain such a database. In stead, SSG 108 passes notification of PSTN events to IP application server 106. IP application server 108 may store a database of DNs and corresponding instructions for responding to or providing subscriber notification of PSTN triggers.

In one example, in response to receiving notification of a PSTN event concerning a DN for which IP application server stores trigger information, IP application server 106 may send a message to computer 102 via IP network 107 for indicating triggering of the call event. Subscriber 100 may view an indication of triggering of the call event on computer 102 and input instructions for executing a PSTN call control function related to the call event. The instructions may be communicated to IP application server 106 via IP network 107. IP application server 106 may analyze the instructions, generate a SIP message 126 specifying the PSTN call control function based on the instructions, and communicate SIP message 126 to SSG 108.SSG 108 may receive SIP message 126 (block 212). Further, in response to receiving SIP message 126, SSG 108 may generate an SS7 message 128 specifying the PSTN call control function associated with subscriber 100, and route SS7 message 128 to SSP switch 110 (block 214). SSP switch may receive SS7 message 128 and implement the PSTN call control function specified therein.

Another advantage of storing subscriber DN and corresponding trigger information at IP application server 106 rather at SSG 108 is that the number of messages required to subscribe to a PSTN event is reduced over that required by the SPIRITs protocol. For example, according to the SPIRITs protocol, a subscribe message is sent from a SPIRITs server to a SPIRITs client for subscribing to a PSTN event. The SPIRITs client sends a first Notify message to the SPIRITs server indicating that the DN specified by the subscribe message is valid. The SPIRITs client then communicates with the PSTN network element-and receives notification that the trigger is armed and updates its database. The SPIRITs client then sends a message to the SPIRITs server indicating that the notification has been armed. Thus, the SPIRITs protocol requires two Notify messages for a SPIRITs client to subscribe to notification of an event. According to the present embodiment, a single Subscribe and a single Notify message may be used to subscribe to notification of a PSTN event. For example, IP application server 106 may send a Subscribe message to SSG 108 to subscribe to a PSTN event. SSG 108 may generate a corresponding TCAP message and send the message to SSP 106. SSP 106 may confirm that the notification has been set by sending a TCAP response to SSG 108. SSG 108 may send a single notification message to IP application server 106 indicating that the notification has been armed or set in the PSTN.

Yet another enhancement of the subject matter described herein over the SPIRITs protocol is the concept of infinite subscription. For example, in the SPIRITs protocol, each SIP Subscribe message includes an Expires header that carries a nonzero value that defines the finite duration of the associated subscription to receive notification of a PSTN event. When the duration expires, the subscribing node must resubscribe to the event. According to the present subject matter, subscriptions to PSTN events may be infinite. That is, IP application server 106 may send a SIP Subscribe message to SSG 108 for subscribing to a PSTN event. The Subscribe message may include any nonzero value in its Expires field. In response to receiving such a message, SSG 108 may send a corresponding TCAP message to the PSTN network element for subscribing to the event and may treat the subscription as infinite. That is, SSG 108 may continue to communicate notification of occurrences of the subscribed-to PSTN event to IP application server 106 in response to the single subscribe message until the IP application server 106 unsubscribes from the event. Thus, the need for repeated resubscriptions to an event is avoided.

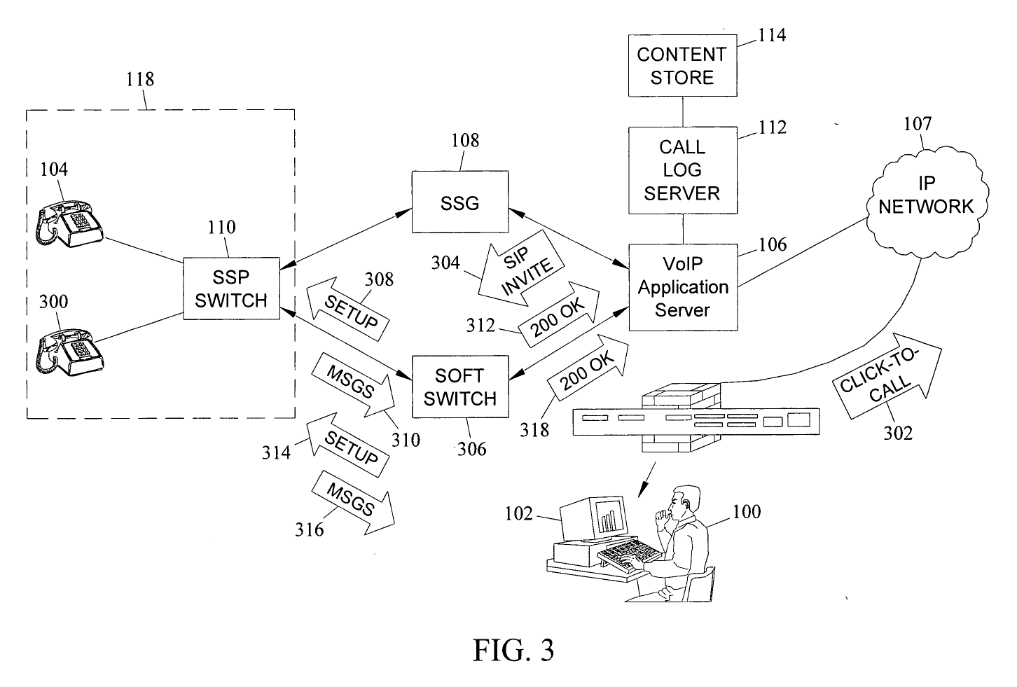

One exemplary service that may be provided by the subject matter described herein is a click to call feature. FIG. 3 illustrates an example of a telecommunications system for providing a click-to-call feature to a circuit switched network subscriber according to an embodiment of the subject matter described herein. Referring to FIG. 3, computer 102 can provide a GUI for allowing subscriber 100 to request click-to-call for setting up, in real time, a call between phone 104, which may be accessible by subscriber 100, and a phone 300. The GUI of computer 102 may receive telephone numbers associated with phones 104 and 300. For example, subscriber 100 may enter the telephone numbers associated with phones 104 and enter a request for a call to be set up between phones 104 and 300. Computer 112 may then communicate a click-to-call instruction message 302 to IP application server 106 for setting up a call between phones 104 and 300. Message 302 may include the directory numbers associated with phones 104 and 300.

IP application server 106 may receive message 302 and, in response to receipt of message 302, generate and communicate a SIP Invite message 304 to a softswitch 306 for setting up a call between phones 104 and 300. Next, softswitch 306 may generate and communicate a Setup message 308 to SSP switch 110. Switch 110 may respond to softswitch 306 with CallProc, Alert, and Conn messages 310. In response to receiving messages 310, softswitch 306 may send a 200 OK SIP message 312 to server 106. Further, softswitch 306 may set up trunk connections to Class 5 switching equipment by sending a Setup message 314 to the Class 5 switching equipment via switch 110 for a directory number (DN) for phone 300. The Class 5 equipment may respond with Call Proc, Alert, and Conn messages 316. Softswitch 136 may send another 200 OK SIP message 318 to server 106. Next, softswitch 306 and server 120 may interface for connecting the two calls with a Two B-Channel Transfer (TBCT) process. Thus, by selecting the click-to-call feature at computer 102, subscriber 100 may establish a call between phones 106 and 300.

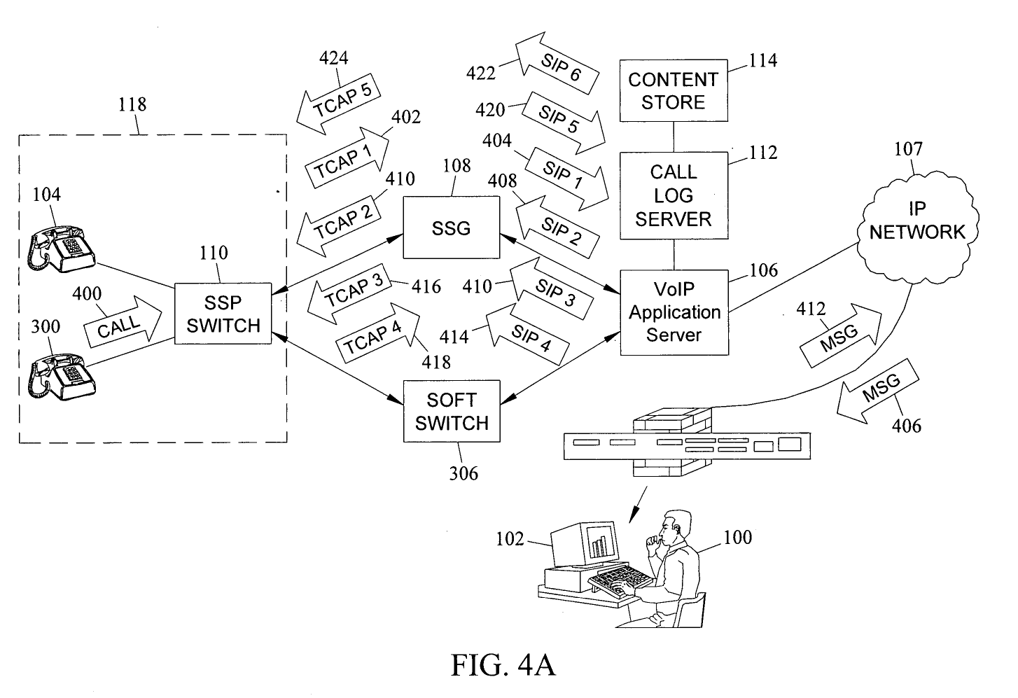

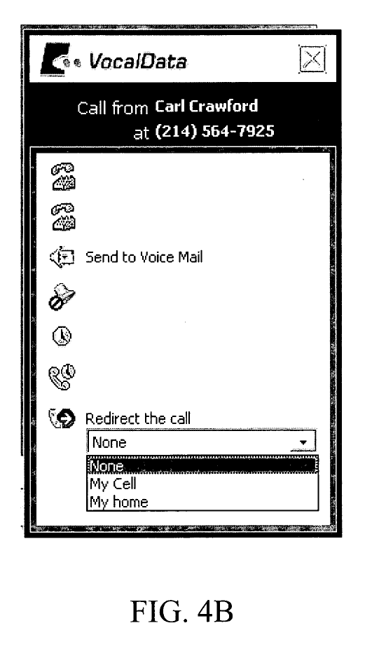

FIG. 4A illustrates an example of a telecommunications system for providing a dynamic incoming call redirect feature using signaling according to an embodiment of the subject matter described herein. Referring to FIG. 4A, computer 102 can provide a GUI for allowing subscriber 100 to dynamically redirect an incoming call 400 originating from phone 300 in circuit switched network 118. Call 400 is a termination attempt to a directory number (DN) associated with subscriber 100. For example, the termination attempt may be directed to a mobile terminal associated with subscriber 100. SSP 110 may receive call 400 and determine whether a call event trigger is triggered by call 400. In this example, SSP 110 has a call event trigger associated with incoming calls associated with a termination attempt to the directory number. On triggering of the call event trigger by incoming call 400, SSP 110 may generate a TCAP termination attempt message 402 carrying termination attempt information indicating an incoming call associated with the to directory number associated with subscriber 100. The call event trigger may have been set by subscriber 100 in accordance with processes described herein.

In response to receiving message 402, SSG 108 may generate and route a SIP message 404 carrying the termination attempt information to application server 106 for indicating triggering of the termination attempt to the directory number associated with subscriber 100. In response to receiving SIP message 404 indicating the termination attempt, application server 106 may generate and communicate a message 406 to computer 102 via IP network 107 for indicating the termination attempt. Notification of the termination attempt may be viewed by subscriber 100 on a pop-up window displayed by computer 102. FIG. 4B illustrates a screen display of an exemplary pop-up window for indicating an incoming call and a name and directory number associated with the call. In FIG. 4B, the graphical user interface presents the user with several options for dynamically controlling the call using signaling according to an embodiment of the subject matter described herein. Illustrated options includes sending the call to voicemail or dynamically redirecting the call to an alternate phone, such as the subscriber's home or cell phone.

Returning to FIG. 4A, in response to receiving SIP message 404 indicating the termination attempt, application server 106 may generate and communicate a SIP SendtoResource message 408 to SSG 108 for rerouting the incoming call to a central office (CO)—interactive voice response (IVR) resource for managing the incoming call. The CO-IVR resource may manage the call until an instruction for managing the call is provided by subscriber 100 or until a time out. In response to receiving message 408, SSG 108 may generate and communicate an SS7 SendtoResource message 410 to SSP 110 for rerouting the incoming call to the CO-IVR resource. In response, SSP 110 may reroute the incoming call to the CO-IVR resource.

Alternatively, message 410 can include instructions for answering the call, not answering the call, and indicating that the calling party that the called party is busy. Further, message 410 may provide instructions for sending notifications about the status of the call, such as a call termination event.

Subscriber 100 may enter an instruction into computer 100 for forwarding the call to another directory number. For example, subscriber 100 may use an input interface of computer 100 for redirecting the call in real-time to another number associated with phone 104 accessible by subscriber 100. Computer 100 may generate and communicate a message 412 to application server 106 via IP network 107 for forwarding the call to phone 104.

In response to receiving message 412, application server 106 may generate and communicate a SIP CancelResourceEvent message 414 to SSG 108 for canceling management of the call by the CO-IVR resource. In response to receiving message 414, SSG 108 may generate and communicate an SS7 CancelResourceEvent message 416 to SSP 110 for canceling management of the call by the CO-IVR resource. In response to receiving message 416, SSP 110 may communicate a message to the CO-IVR resource with instructions to cancel management of the call.

The CO-IVR may cancel management of the call. SSP 110 may determine cancellation of the call and communicate an SS7 TCAP ResourceClear message 418 to SSG 108 for indicating cancellation of the resource management. In response to receiving message 418, SSG 108 may generate and communicate an SIP ResourceClear message 420 to application server 106 for indicating cancellation of the resource management.

Application server 106 may generate and communicate a SIP ForwardCall message 422 to SSG 108 for forwarding the call to the other directory number. In response to receiving message 422, SSG may generate and communicate an SS7 ForwardCall message 424 to SSP 110 for forwarding the call to the other directory number. In response to receiving message 422, SSP switch 110 may forward the call to phone 104. Thus, this exemplary process results in dynamic redirecting of an incoming call by subscriber 100 at computer 102 to phone 104.

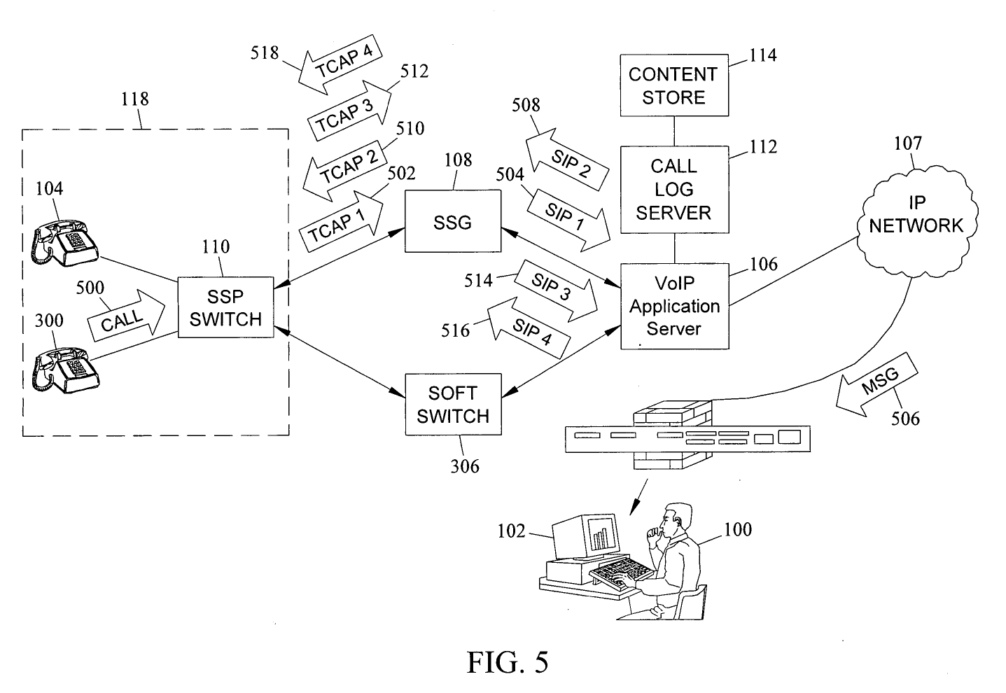

According to one embodiment, an incoming call may be dynamically rerouted to a CO-IVR resource in response to triggering. If the calling party disconnects, the call may be managed for disconnecting the call. FIG. 5 illustrates an example of a telecommunications system for providing a dynamic incoming call feature to a subscriber where a calling party disconnects according to an embodiment of the subject matter described herein. Referring to FIG. 5, an incoming call 500 originating from phone 300 may be received by SSP 110. Call 500 is a termination attempt to a directory number associated with subscriber 100. SSP 110 may receive call 500 and determine whether a call event trigger is triggered by call 500. In this example, SSP 110 has a termination event trigger set for incoming calls to the directory number. On triggering of the termination attempt event trigger by incoming call 500, SSP 110 may generate a TCAP message 502 carrying termination attempt information indicating an incoming call associated with the directory number associated with subscriber 100. The termination attempt trigger may have been set by subscriber 100 in accordance with processes described herein.

In response to receiving message 502, SSG 108 may generate and route a SIP message 504 to application server 106 for indicating triggering of the termination attempt to the directory number associated with subscriber 100. In response to receiving SIP message 504 indicating the termination attempt, application server 106 may generate and communicate a message 506 to computer 102 via IP network 107 for indicating the termination attempt. Notification of the termination attempt may be viewed by subscriber 100 on a pop-up window displayed by computer 102.

Further, in response to receiving SIP message 504 indicating the termination attempt, application server 106 may generate and communicate a SIP SendtoResource message 508 to SSG 108 for rerouting the incoming call to a CO-IVR resource for managing the incoming call. In response to receiving message 508, SSG 108 may generate and communicate an SS7 SendtoResource message 510 to SSP switch 110 for rerouting the incoming call to the CO-IVR resource. In response SSP switch 110 may reroute the incoming call to the CO-IVR resource.

The calling party associated with phone 300 may disconnect the call. In response, SSP switch 110 may generate and communicate an SS7 ResourceClear message 512 to SSG 108 for indicating the call disconnect. In response to receiving message 512, SSG 108 may generate and communicate an SIP ResourceClear message 514 to application server 120 for indicating the call disconnect.

In response to receiving message 514, application server 120 may generate and communicate to SSG 108 a SIP Continue message 516 for continuing disconnection of the call. SSG 108 may generate and communicate to SSP switch 110 an SS7 Continue message 518 for continuing disconnection of the call. SSP switch 110 may then disconnect the call.

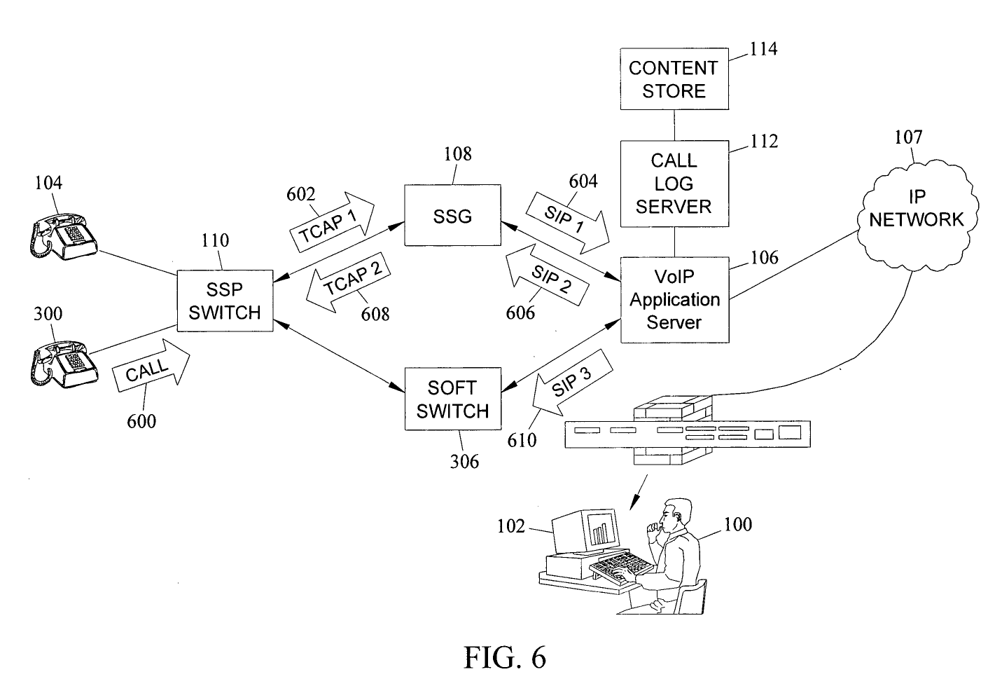

According to one embodiment, a find-me/simulation ring feature may be provided to a circuit switched network subscriber in accordance with the subject matter described herein. The find-me/simulation ring feature may include determining that an incoming call should be forwarded to another number associated with a subscriber, determining the other number associated with the subscriber, and forwarding the call to the other number. The call may be forwarded to the other number and appear to the calling party that the call was not forwarded. FIG. 6 illustrates an example of a telecommunications system for providing a find-me/simulation ring feature to a circuit switched network subscriber according to an embodiment of the subject matter described herein. Referring to FIG. 6, an incoming call 600 originating from phone 300 may be received by SSP switch 110. Call 600 is a termination attempt to a directory number associated with subscriber 100. SSP switch 110 may receive call 600 and determine whether a call event trigger is triggered by call 600. In this example, SSP switch 110 has a call event trigger associated with incoming calls associated with a termination attempt to the directory number. On triggering of the call event trigger by incoming call 600, SSP switch 110 may generate a TCAP termination attempt message 602 indicating an incoming call associated with the directory number associated with subscriber 100. Further, SSP switch 110 may be routed to SSG 108. The call event trigger may have been set by subscriber 100 in accordance with processes described herein.

In response to receiving message 602, SSG 108 may generate and route a SIP termination attempt message 604 to application server 106 for indicating triggering of the termination attempt to the directory number associated with subscriber 100. In response to receiving SIP message 604 indicating the termination attempt, application server 106 may include a call event trigger for setting up a call between a calling party to a predetermined directory number and phone 104 accessible by subscriber 100 when receiving notification of an incoming call to the directory number. For example, subscriber 100 may use computer 102 for setting up the call event trigger to set up the incoming call to phone 104.

Application server 106 may determine that the call event trigger is triggered by message 604. In response to determining triggering of the call event trigger, application server 106 may generate and communicate to SSG 108 a SIP message 606 for indicating that the incoming call is to be forwarded to softswitch 306. In response to receiving message 606, SSG 108 may generate and communicate to SSP switch 110 an SS7 ForwardCall message 608 for forwarding the incoming call to softswitch 306. In response to receiving message 608, SSP switch 110 may reroute the incoming call to softswitch 306.

Softswitch 306 may interface with application server 106 for connecting the call to an announcement. For example, an IVR function may play an announcement to the calling party that indicates that the call is being forwarded to another terminal.

Application server 106 may generate and communicate to softswitch 306 a SIP Invite message 610 indicating one or more directory numbers associated with subscriber 100. In response to receiving message 610, softswitch 306 may generate and communicate one or more TCAP Setup messages to Class 5 switching equipment for the directory numbers associated with subscriber 100. The Class 5 equipment may respond with Call Proc, Alert, and Conn messages. Softswitch 306 may send a 200 OK SIP message to application server 106. Next, softswitch 306 and application server 106 may interface for disconnecting the IVR function. Further, softswitch 306 and application server 106 may interface for connecting two calls between phone 300 and a terminal accessible by subscriber 100 with a Two B-Channel Transfer (TBCT) process. Calls to other terminals may be disconnected.

In one embodiment, an IP application server address may provide address book management tools to a subscriber. Referring to FIG. 1, for example, subscriber 100 may access a web interface provided by application server 106 by using computer 102. Subscriber 100 may interface with computer 102 for requesting address information from application server 106 via the web interface. In response to the request, application server 106 may communicate address book information for a phone to computer 102, which may display the address book information to subscriber 100. The displayed address book information may be sorted by name, phone number, title, and other suitable address information. The address book information may be updated from log files and manual entries provided by computer 102. The updated information may be provided to application server 106 from computer 102. Further, the address book information stored at application server 106 may be updated by call log server 112 with call log information stored at content store 114. Subscriber 100 may call a name or phone number associated with an entry by using a click-to-dial feature as described herein.

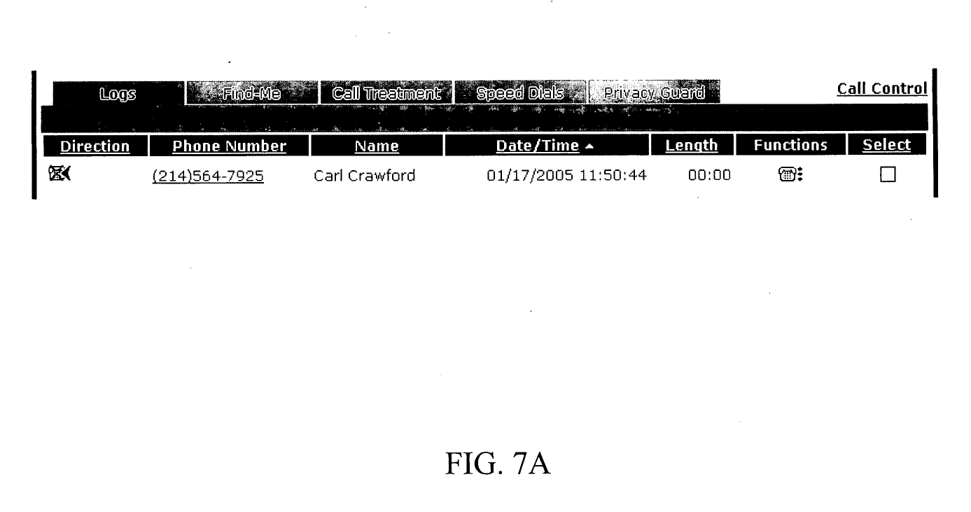

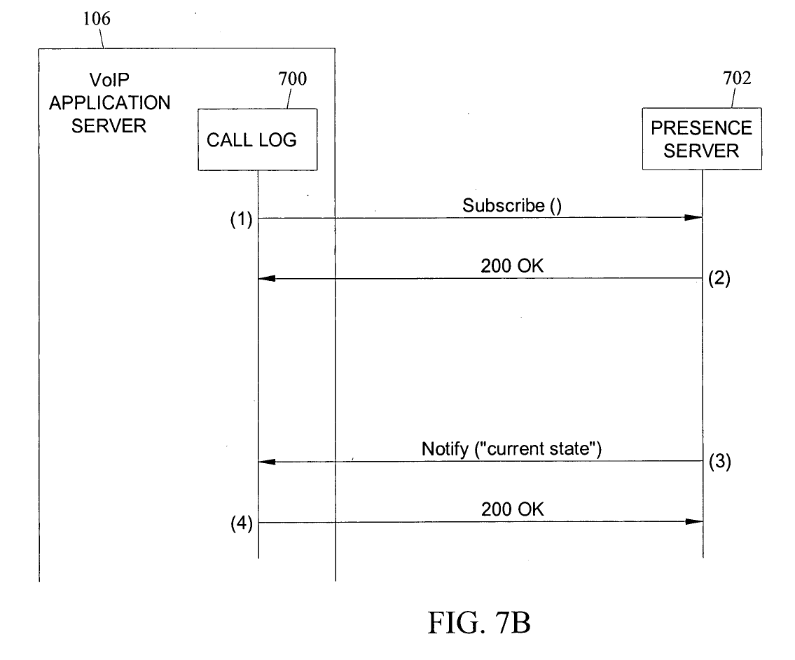

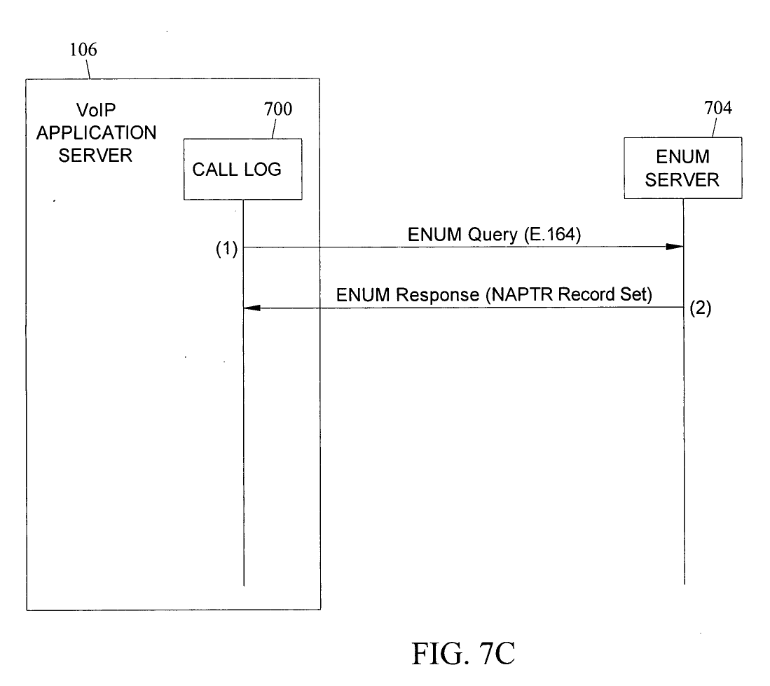

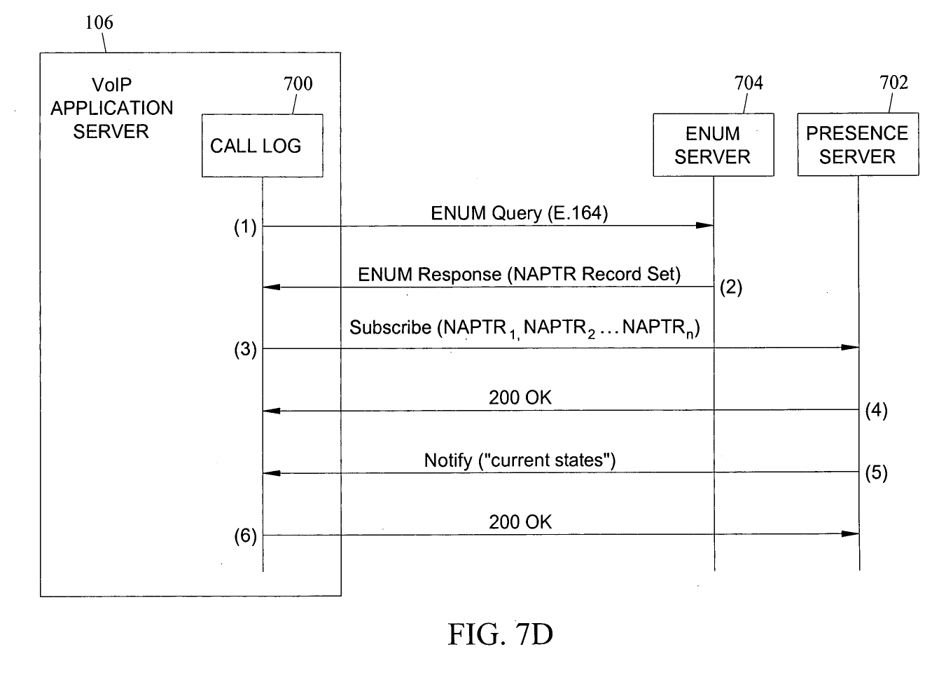

In one embodiment, an IP application server may provide call log information and management tools to a subscriber. Referring to FIG. 1, for example, subscriber 100 may access a web interface provided by application server 106 by using computer 102. Subscriber 100 may interface with computer 102 for requesting call log information from application server 106 via the web interface. In response to the request, application server 106 may communicate call log information for a phone to computer 102, which may display the call log information to subscriber 100. The displayed call log information may be sorted by call direction, phone number, date, and other suitable call log information. For example, the call log information may include historical call activity, such as completed outbound calls, completed inbound calls, attempted outbound calls, and missed inbound calls. Subscriber 100 may call a name or phone number associated with an entry by using a click-to-dial feature as described herein. Call log information may be used for updating a contact list stored at computer 102. Further, subscriber 100 may click a function to add a call log entry to a call log management section of application server 106 for specific call treatments for future calls to a directory number associated with subscriber 100. Call log information provided to computer 102 may be exported to a computer program. FIG. 7A illustrates a screen display of an exemplary call log entry according to an embodiment of the subject matter described herein.

The ability to view calls to phones from a remote location may be beneficial, for example, because a subscriber may view calls to a home phone at a remote location remote from the phone. For example, calls to a home phone may be viewed at an office or hotel. The calls may be displayed at the remote location through a web browser interface.

According to one embodiment, a VoIP application server may be configured to obtain and present presence information associated with subscribers listed in a call log. Presence information is information about the on-line activity and status of users on a network that is obtained from a presence server by subscribing to a user in the presence server. Presence information regarding a subscribed-to user may be delivered to a subscriber in response to changes in status of the subscribed-to user. FIG. 7B is a message flow diagram illustrating an exchange of messages between a VoIP application server and a presence server for obtaining subscriber presence information according to an embodiment of the subject matter described herein. The subscriber presence information may be obtained for some of all of the subscribers by using a SIP subscribe/notify message exchange process. Referring to FIG. 7B, VoIP application server 112 may include a call log function 700 operable to maintain a list of subscribers and operable to communicate with a presence server 702 over an IP network. In step 1, call log function 700 may communicate a SIP Subscribe message to presence server 702 for subscribing to receive presence information for a list of subscribers. In step 2, presence server 702 may respond to call log function 700 with a 200 OK SIP message. Presence server 702 may obtain presence information for the listed subscribers. In step 3, presence server 702 may communicate a SIP Notify message including presence information for the listed subscribers. Call log function 700 may receive and store the presence information. In step 4, call log function 700 may respond to presence server 702 with a 200 OK SIP message. Presence server 702 may provide presence information updates to call log function 700 for the subscribers. The presence information may be stored in a call log record and associated with a name, entry, and/or other calling or called party-related information.

According to one embodiment, a VoIP application server may be configured to obtain and NAPTR information associated with subscribers listed in a call log. NAPTR information refers to Naming Authority Pinter information and is DNS information obtained in response to an E.164 numbering (ENUM) query regarding a phone number. One example of NAPTR information that may be returned in response to an ENUM query is one or more SIP URIs. FIG. 7C is a message flow diagram illustrating an exchange of messages between a VoIP application server and an ENUM server for obtaining NAPTR information according to an embodiment of the subject matter described herein. Referring to FIG. 7C, call log function 700 may be operable to communicate with an ENUM server 704 for obtaining NAPTR information. In step 1, call log function 700 may communicate an ENUM query message including one or more E.164-formatted subscriber numbers for a list of subscribers. ENUM server 704 may obtain the corresponding DNS information for the listed subscribers by accessing the NAPTR records. In step 2, ENUM server 704 may respond to call log function 700 with an ENUM Response message including a set of NAPTR records associated with the subscriber identifiers. Each NAPTR record may contain a subscriber identifier or address, such as a SIP URI. ENUM server 704 may provide reachability information updates to call log function 700 for the subscribers. Further, VoIP application server 112 may communicate the NAPTR record information to computer 102 for presentation to subscriber 100. Further, subscriber 100 may interface with computer 102 to select a NAPTR address at which to contact a party by using the click-to-dial feature as described herein. The reachability information may be stored in a call log record and associated with a name, entry, and/or other calling or called party-related information.

According to another aspect of the subject matter described herein, call log function 700 may use NAPTR record information for obtaining presence information from presence server 702. FIG. 7D is a message flow diagram illustrating an exchange of messages between call log function 700, presence server 702, and ENUM server 704 for obtaining subscriber presence information according to an embodiment of the subject matter described herein. In step 1 of FIG. 7D, call log function 700 may communicate an ENUM query message including one or more E.164-formatted numbers for a list of subscribers. ENUM server 704 may obtain NAPTR information for the listed subscribers. In step 2, ENUM server 704 may respond to call log function 700 with an ENUM Response message including a set of NAPTR records associated with the subscriber identifiers. In step 3, call log function 700 may communicate a SIP Subscribe message to presence server 702 for subscribing presence information for the subscribers identified by the NAPTR records. In step 4, presence server 702 may respond to call log function 700 with a 200 OK SIP message. Presence server 702 may obtain presence information for the listed subscribers identified by the NAPTR records. In step 5, presence server 702 may communicate a SIP Notify message including presence information associated with the subscribers identified by the NAPTR records. Call log function 700 may receive and store the presence information. In step 6, call log function 700 may respond to presence server 702 with a 200 OK SIP message. Presence server 702 may provide presence information updates to call log function 700 for the subscribers identified by the NAPTR records. VoIP application server 112 may communicate the presence information obtained for the subscribers identified by the NAPTR records to computer 102 for presentation to subscriber 100. Further, subscriber 100 may interface with computer 102 to select a NAPTR address at which to contact a party by using the click-to-dial feature as described herein. Because the subscriber has NAPTR records and corresponding presence information, the subscriber can select the most appropriate NAPTR record for contacting another subscriber.

In one embodiment, an IP application server may provide call treatment services to a subscriber. Examples of call treatment services include screening incoming calls and allowing important calls to pass while routing others to voicemail. Referring to FIG. 1, for example, subscriber 100 may access a web interface provided by application server 106 by using computer 102. Subscriber 100 may interface with computer 102 for specifying call management. Application server 106 may communicate call treatment information to computer 102 for use in specifying call management. Computer 102 may display call management features to subscriber 100.

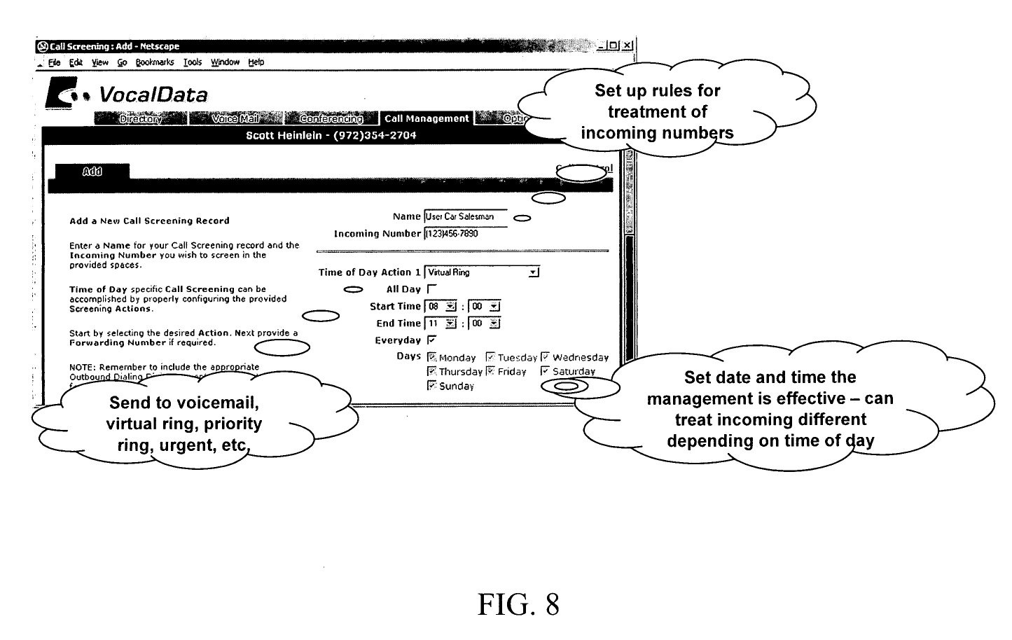

FIG. 8 is a screen display for selecting call management features according to an embodiment of the subject matter described herein. Referring to FIG. 8, a user can input information for setting up rules for treatment of incoming calls to a predetermined directory number. For example, a subscriber can select to send the incoming call to voicemail, provide a virtual ring, a priority ring, or an urgent notification for the call. Further, the subscriber may set a date and time when the treatment rule is effective such that different call may be treated differently depending on a date and time. Call screening can be used for important calls or emergency calls. A subscriber may also configure call treatment and speed dials using a screen display at computer 102. A subscriber may also specify to ignore a call, call the calling party later, redirect the call to another number, and provide a visual call waiting feature.

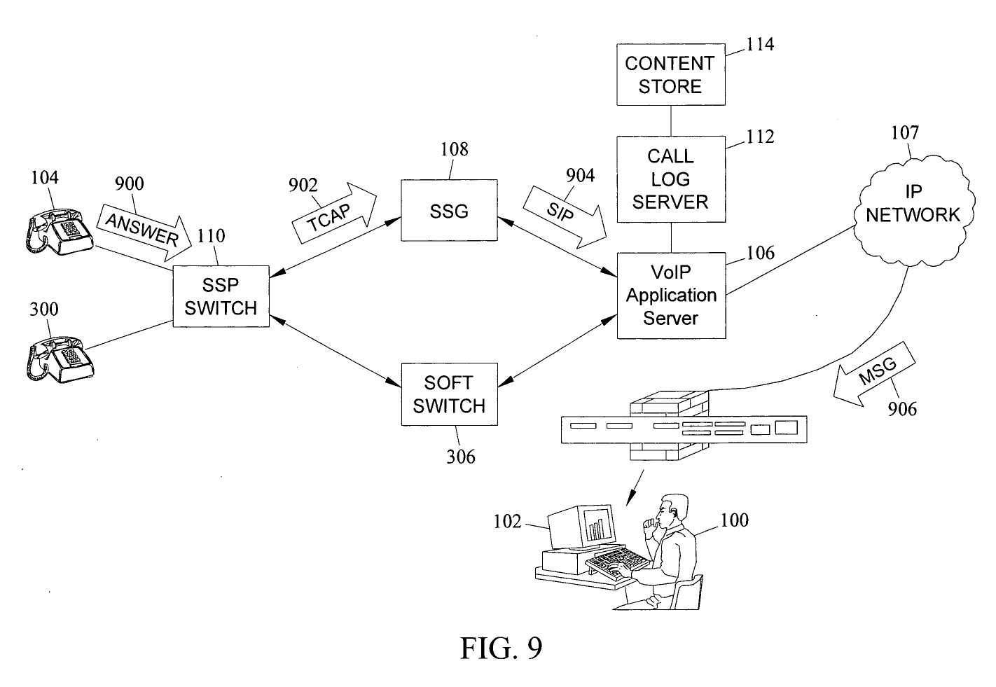

According to one embodiment, the subject matter described herein provides for notifying a circuit switched network subscriber that an incoming call was locally answered. FIG. 9 illustrates a telecommunications system exchanging messages in an exemplary scenario of monitoring an incoming call that is locally answered and indicating that the call was answered according to an embodiment of the subject matter described herein. The messages described in this exemplary scenario can be exchanged after the exchange of messages described with respect to FIG. 4A. With respect to FIG. 4A, messages are exchanged for notifying subscriber 100 at computer 102 of an incoming call. Referring to FIG. 9, SSP switch 110 can be set to trigger when the incoming call is answered. For example, a call to phone 104 may be answered. SSP switch 110 may receive an answer message 900 indicating answering of the call to phone 104. In response to receiving answer message 900, SSP switch 110 may generate and communicate to SSG 108 a TCAP T_Answer notification message 902 for indicating that the incoming call was locally answered. In response to receiving message 902, SSG 108 may generate and communicate to application server 106 a SIP T_Answer notification message 904 for indicating that the incoming call was locally answered. In response to receiving message 904, application server 106 may generate and communicate to computer 102 a message 906 for indicating that the incoming call was locally answered. Computer 102 may display a window on a GUI for indicating to subscriber 102 that the incoming call was locally answered. The call activity may be logged by call log server 112.

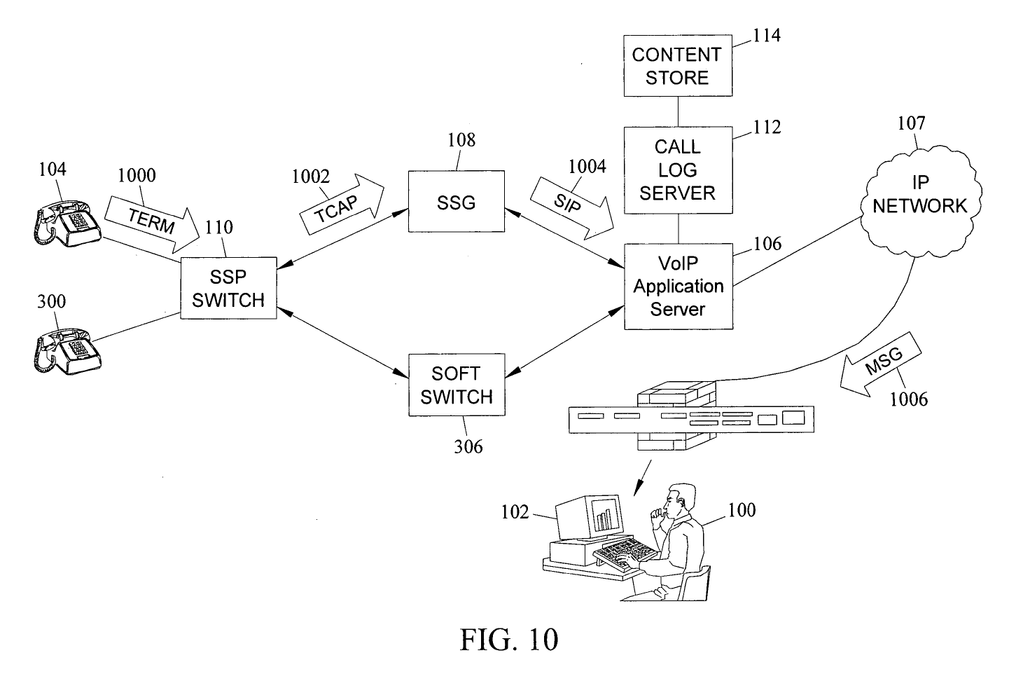

According to one embodiment, the subject matter described herein provides for notifying a circuit switched network subscriber that an incoming call was locally terminated. FIG. 10 illustrates a telecommunications system exchanging messages in an exemplary scenario of monitoring an incoming call that is locally answered and indicating that the call was terminated according to an embodiment of the subject matter described herein. The messages described in this exemplary scenario can be exchanged after the exchange of messages described with respect to FIG. 4A. With respect to FIG. 4A, messages are exchanged for notifying subscriber 100 at computer 102 of an incoming call. Referring to FIG. 10, SSP 110 may be set to trigger when the incoming call is abandoned. For example, a call to phone 104 may be terminated. SSP 110 may receive a termination message 1000 indicating termination of the call to phone 104. In response to receiving termination message 1000, SSP 110 may generate and communicate to SSG 108 a TCAP Termination Notification message 1002 for indicating that the incoming call was terminated. In response to receiving message 1002, SSG 108 may generate and communicate to application server 106 a SIP OPTIONS message 1004 for indicating that the incoming call was locally answered. In response to receiving message 1004, application server 106 may generate and communicate to computer 102 a message 1006 for indicating that the incoming call was terminated. Computer 102 may display a window on a GUI for indicating to subscriber 102 that the incoming call was terminated. The call activity may be logged by call log server 112.

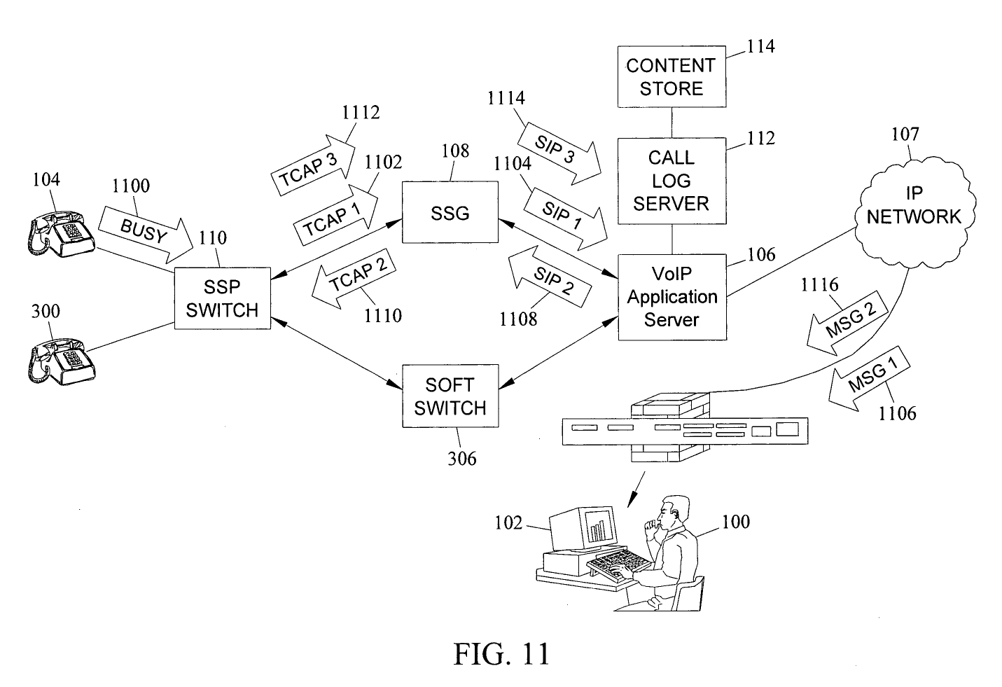

FIG. 11 illustrates a telecommunications system exchanging messages in an exemplary scenario of managing an incoming call to a subscriber phone with no call waiting and that is locally busy according to an embodiment of the subject matter described herein. The messages described in this exemplary scenario can be exchanged after the exchange of messages described with respect to FIG. 4A. With respect to FIG. 4A, messages are exchanged for notifying subscriber 100 at computer 102 of an incoming call. Referring to FIG. 11, SSP switch 110 may be set to trigger when it detects that called phone 104 is busy. For example, SSP switch 110 may receive a busy message 1100 indicating that phone 104 is busy. In response to receiving busy message 1100, SSP switch 110 may generate and communicate to SSG 108 a TCAP T_Busy message 1102 for indicating that phone 104 is busy. In response to receiving message 1102, SSG 108 may generate and communicate to application server 106 a SIP T_Busy message 1104 for indicating that that phone 104 is busy. In response to receiving message 1104, application server 106 may generate and communicate to computer 102 a message 1106 for indicating that the called party line is busy. Computer 102 may display a window on a GUI for indicating to subscriber 102 that that phone 104 is busy. The call activity may be logged by call log server 112.

Application server 106 may respond to message 1104 with a SIP Continue message 1108 for continuing the call to phone 104. In response to receiving SIP Continue message 1108, SSG 108 may generate and communicate to SSP switch 110 a TCAP Continue message 1110 for continuing the call to phone 104.

SSP switch 110 may detect no call waiting service for phone 104, and, in response to the detection, return a busy tone to calling phone 300. In response to the busy tone, calling phone 300 may be disconnected by its user. In response to detecting disconnection, SSP 110 may generate and communicate to SSG 108 a TCAP TerminationNotification message 1112 for indicating that the incoming call was terminated. In response to receiving message 1002, SSG 108 may generate and communicate to application server 106 a SIP TerminationNotification message 1114 for indicating that that the incoming call was terminated. In response to receiving message 1114, application server 106 may generate and communicate to computer 102 a message 1116 for indicating that the incoming call was terminated. Computer 102 may update the call status to indicate that the incoming call was terminated. The call activity may be logged by call log server 112.

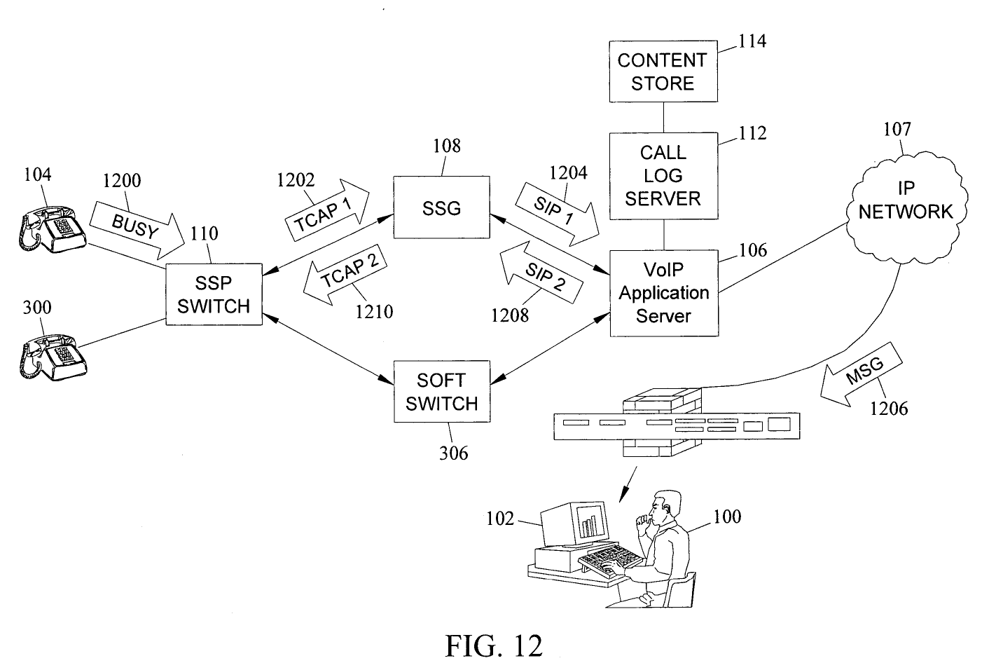

FIG. 12 illustrates a telecommunications system exchanging messages in an exemplary scenario of forwarding an incoming call to another phone according to an embodiment of the subject matter described herein. The messages described in this exemplary scenario can be exchanged after the exchange of messages described with respect to FIG. 4A. With respect to FIG. 4A, messages are exchanged for notifying subscriber 100 at computer 102 of an incoming call. Referring to FIG. 12, SSP 110 may be set to trigger when it detects that called phone 104 is busy. For example, SSP switch 110 may receive a busy message 1200 indicating that phone 104 is busy. In response to receiving busy message 1200, SSP switch 110 may generate and communicate to SSG 108 a TCAP T_Busy message 1202 for indicating that phone 104 is busy. In response to receiving message 1202, SSG 108 may generate and communicate to application server 106 a SIP T_Busy message 1204 for indicating that that phone 104 is busy. In response to receiving message 1204, application server 106 may generate and communicate to computer 102 a message 1206 for indicating that the called party line is busy. Computer 102 may display a window on a GUI for indicating to subscriber 102 that that phone 104 is busy. The call activity may be logged by call log server 112.

Application server 106 may respond to message 1204 with a SIP ForwardCall message 1208 for forwarding the call to a predetermined directory number. The predetermined directory number may be set by subscriber 100 by using computer 102. In response to receiving message 1208, SSG 108 may generate and communicate to a TCAP ForwardCall message 1210 to direct SSP switch 110 to forward the incoming call to the predetermined directory number, which may be associated with a phone accessible by subscriber 100. SSP switch 110 may reroute the incoming call to the predetermined directory number.

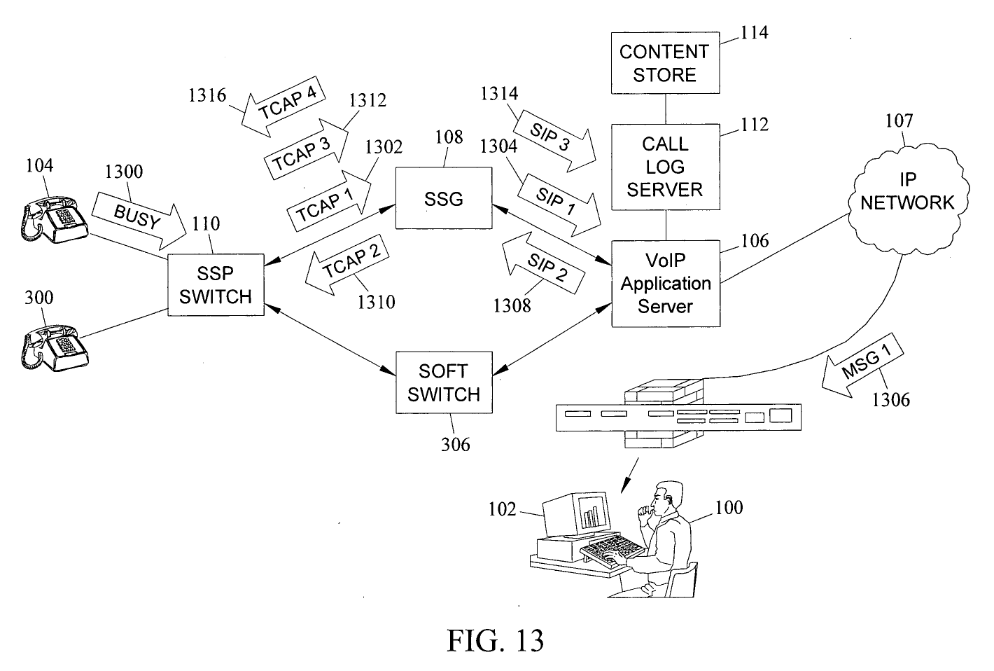

FIG. 13 illustrates a telecommunications system exchanging messages in an exemplary scenario of receiving indication of an incoming call to a busy phone and managing the call according to an embodiment of the subject matter described herein. The messages described in this exemplary scenario can be exchanged after the exchange of messages described with respect to FIG. 4A. With respect to FIG. 4A, messages are exchanged for notifying subscriber 100 at computer 102 of an incoming call. Referring to FIG. 13, SSP switch 110 may be set to trigger when it detects that called phone 104 is busy. For example, SSP switch 110 may receive a busy message 1300 indicating that phone 104 is busy. In response to receiving busy message 1300, SSP switch 110 may generate and communicate to SSG 108 a TCAP T_Busy message 1302 for indicating that phone 104 is busy. In response to receiving message 1302, SSG 108 may generate and communicate to application server 106 a SIP T_Busy message 1304 for indicating that that phone 104 is busy. In response to receiving message 1304, application server 106 may generate and communicate to computer 102 a message 1306 for indicating that the called party line is busy. Computer 102 may display a window on a GUI for indicating to subscriber 102 that that phone 104 is busy. The call activity may be logged by call log server 112.

Application server 106 may respond to message 1304 with a SIP {[OfferCall], RRBE[T_Answer, T_No_Answer]} message 1308 for providing call waiting service to the incoming call. In response to receiving message 1308, SSG 108 may generate and communicate to SSP switch 110 a TCAP OfferCall message 1310 in a multi-component package for providing call waiting service to the incoming call.

SSP 110 may detect no answer at phone 104. In response to detecting no answer, SSP switch 110 may generate and communicate to SSG 108 a TCAP T_No_Answer message 1312 for indicating no answer to the incoming call. In response to receiving message 1312, SSG 108 may generate and communicate to application server 106 a SIP T_No_Answer message 1314 for indicating no answer to the incoming call.

In response to receiving message 1314, application server 106 may generate and communicate to SSG 108 a SIP ForwardCall message. 1316 for forwarding the call to a predetermined directory number. The predetermined directory number may be set by subscriber 100 by using computer 102. In response to receiving message 1314, SSG 108 may generate and communicate to a TCAP ForwardCall message 1316 to direct SSP switch 110 to forward the incoming call to the predetermined directory number, which may be associated with a phone accessible by subscriber 100. SSP switch 110 may reroute the incoming call to the predetermined directory number.

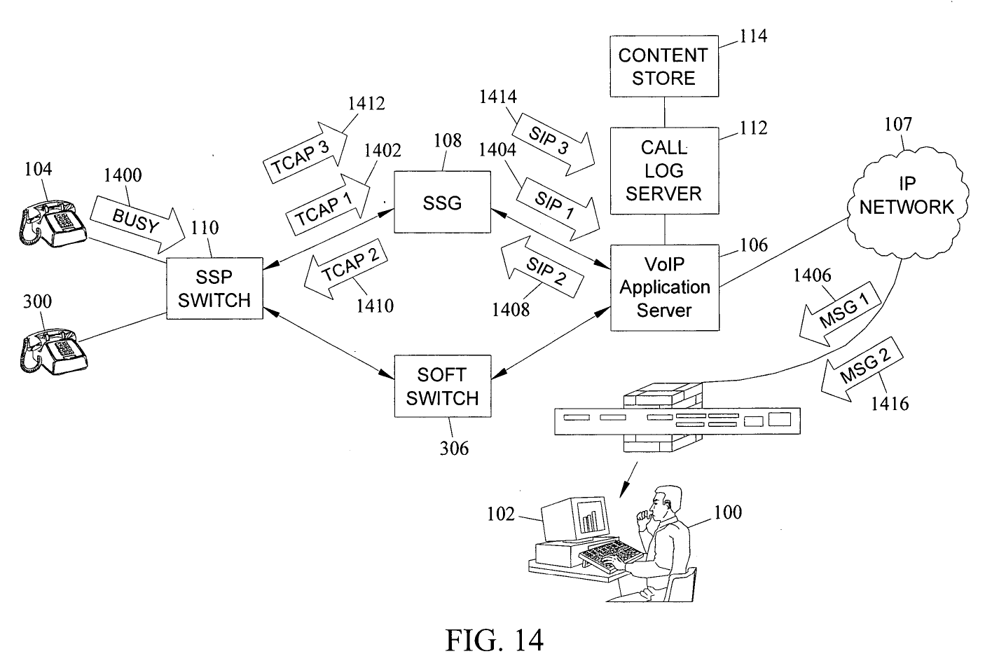

FIG. 14 illustrates a telecommunications system exchanging messages in an exemplary scenario of an incoming call to a busy phone according to an embodiment of the subject matter described herein. The messages described in this exemplary scenario can be exchanged after the exchange of messages described with respect to FIG. 4A. With respect to FIG. 4A, messages are exchanged for notifying subscriber 100 at computer 102 of an incoming call. Referring to FIG. 14, SSP switch 110 may be set to trigger when it detects that called phone 104 is busy. For example, SSP 110 may receive a busy message 1400 indicating that phone 104 is busy. In response to receiving busy message 1400, SSP switch 110 may generate and communicate to SSG 108 a TCAP T_Busy message 1402 for indicating that phone 104 is busy. In response to receiving message 1402, SSG 108 may generate and communicate to application server 106 a SIP T_Busy message 1404 for indicating that that phone 104 is busy. In response to receiving message 1404, application server 106 may generate and communicate to computer 102 a message 1406 for indicating that the called party line is busy. Computer 102 may display a window on a GUI for indicating to subscriber 102 that that phone 104 is busy. The call activity may be logged by call log server 112.

Application server 106 may respond to message 1404 with a SIP {[Continue], RRBE[T_Answer]} message 1408 for providing call waiting service to the incoming call. In response to receiving message 1408, SSG 108 may generate and communicate to SSP switch 110 a TCAP Continue message 1410 in a multi-component package for providing call waiting service to the incoming call.

SSP switch 110 may detect an answer to the incoming call from phone 300 to phone 104. In response to detecting the answer, SSP switch 110 may generate and communicate to SSG 108 a TCAP T_Answer message 1412 for indicating the answer. In response to receiving message 1412, SSG 108 may generate and communicate to application server 106 a SIP T_Answer message 1414 for indicating the answer.

In response to receiving message 1414, application server 106 may generate and communicate to computer 102 a message 1416 for indicating that the incoming call was answered. Computer 102 may update its GUI to indicate that the incoming call was answered.

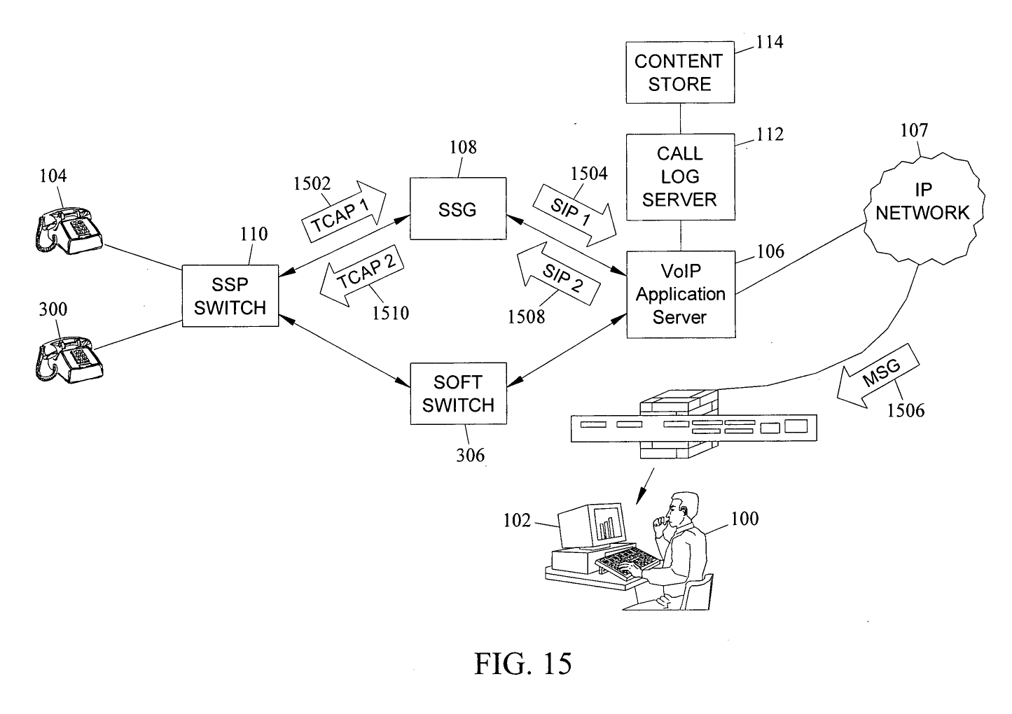

In some instances, a subscriber may wish to receive notification of an incoming call to a PSTN phone but may wish to decline from taking any action to control the call. FIG. 15 illustrates a telecommunications system exchanging messages in an exemplary scenario of providing no action to an incoming call according to an embodiment of the subject matter described herein. The messages described in this exemplary scenario can be exchanged after the exchange of messages described with respect to FIG. 4A. With respect to FIG. 4A, messages are exchanged for notifying subscriber 100 at computer 102 of an incoming call. Referring to FIG. 15, SSP switch 110 may be set to trigger on detection of no answer to an incoming call to phone 104. For example, SSP switch 110 may determine that phone 104 is not being answered based on, for example, an elapsed ring time. In response to determining no answer, SSP switch 110 may generate and communicate to SSG 108 a TCAP T_No_Answer message 1502 for indicating that phone 104 is not being answered. In response to receiving message 1502, SSG 108 may generate and communicate to application server 106 a SIP T_No_Answer message 1504 for indicating that that phone 104 is not being answered. In response to receiving message 1504, application server 106 may generate and communicate to computer 102 a message 1506 for indicating that the incoming call is not being answered. Computer 102 may display a window on a GUI for indicating to subscriber 102 that that phone 104 is not being answered. The call activity may be logged by call log server 112.

Application server 106 may respond to message 1504 with a SIP Continue message 1508 for continuing the ringing phone 104. In response to receiving message 1508, SSG 108 may generate and communicate to SSP switch 110 a TCAP Continue message 1510 for continuing the ringing phone 104. In response to receiving message 1510, SSP switch 110 may permit the continuation of ringing phone 104.

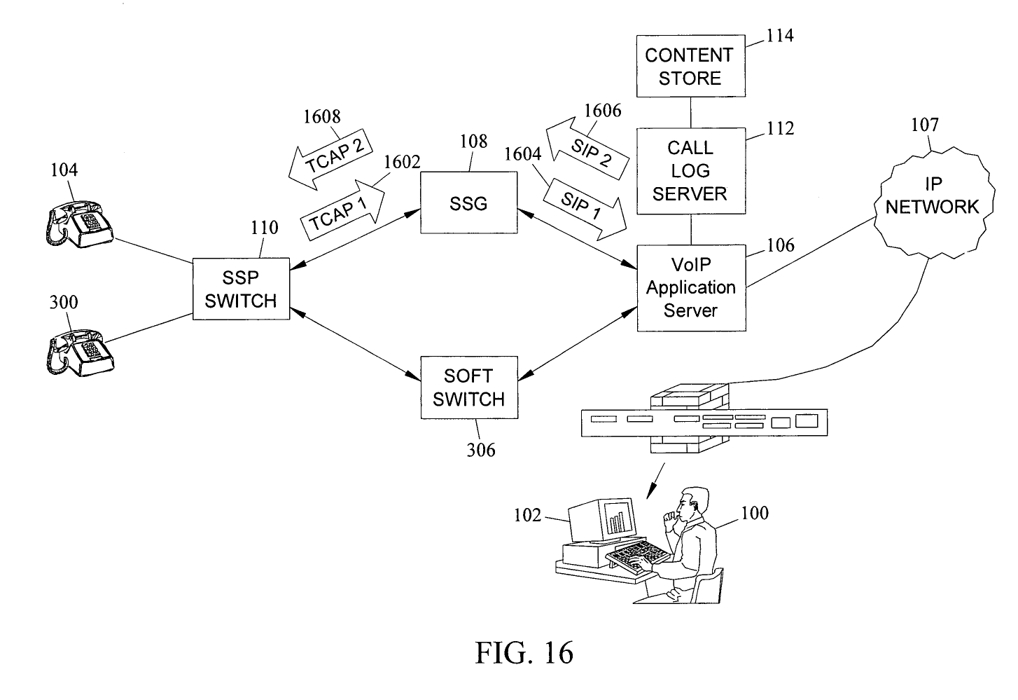

FIG. 16 illustrates a telecommunications system exchanging messages in an exemplary scenario of redirecting an incoming call to voice mail or a mobile phone according to an embodiment of the subject matter described herein. The messages described in this exemplary scenario can be exchanged after the exchange of messages described with respect to FIG. 4A. With respect to FIG. 4A, messages are exchanged for notifying subscriber 100 at computer 102 of an incoming call. Referring to FIG. 16, SSP switch 110 may be set to trigger on detection of no answer to an incoming call to phone 104. For example, SSP switch 110 may determine that phone 104 is not being answered based on, for example, an elapsed ring time. In response to determining no answer, SSP switch 110 may generate and communicate to SSG 108 a TCAP T_No_Answer message 1602 for indicating that phone 104 is not being answered. In response to receiving message 1602, SSG 108 may generate and communicate to application server 106 a SIP T_No_Answer message 1604 for indicating that that phone 104 is not being answered.

In response to receiving message 1604, application server 106 may respond to message 1604 with a SIP ForwardCall message 1606 for forwarding the incoming call to voice mail or a directory number of a mobile phone. In response to receiving message 1606, SSG 108 may generate and communicate to SSP switch 110 a TCAP ForwardCall message 1608 for redirecting the incoming call to voice mail or the directory number of the mobile phone. In response to receiving message 1608, SSP switch 110 may redirect the call.

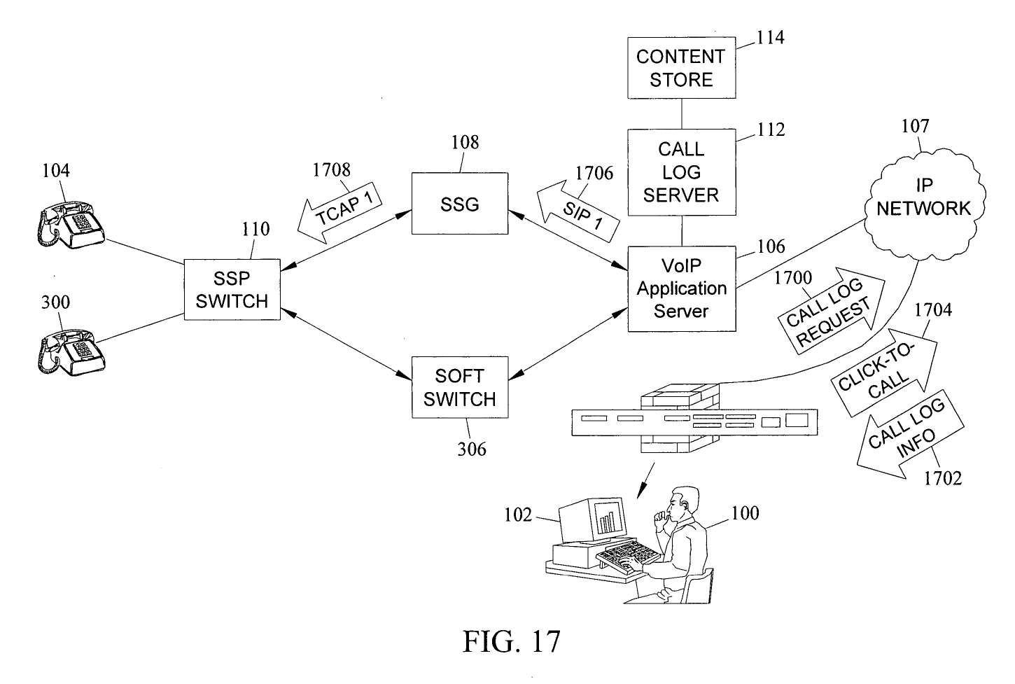

FIG. 17 illustrates another example of a telecommunications system for providing a click-to-call feature according to an embodiment of the subject matter described herein. Referring to FIG. 17, subscriber 100 can enter commands into computer 102 for requesting call log information from application server 106. Computer 102 may send a call log request message 1700 to application server 106 for requesting call log information. Application server 106 may retrieve call log information from call log server 112 for subscriber 100. Application server 106 may send a message 1702 including the call log information to computer 102. The call log information may include a listing of calls associated with subscriber 100. The listing may include directory numbers for the calls.

Computer 102 may display the call log information on a display. For example, the listing of calls with directory numbers may be displayed. Subscriber 100 may select a displayed directory number for setting up a call between phone 104 accessible by subscriber 100 and phone 300 associated with the selected directory number by using the click-to-call feature. Computer 102 may communicate a click-to-call message 704 to application server 106 for setting up a call between phones 104 and 300.

In response to receiving click-to-call message 704, application server 106 may generate and communicate to SSG 108 a SIP {[CreateCall], RRBE[Origination_Attempt, Send_Notification]} message 706 for creating a call between phones 104 and 300. In response to receiving message 706, SSG 108 may generate and communicate to SSP switch 110 a TCAP CreateCall message 708 in a multi-component package for creating a call between phones 104 and 300.

SSP 110 sets up a call for ringing phone 104 accessible by subscriber 100. Phone 104 may go off-hook when subscriber 100 answers phone 104. SSP 110 may detect answering of phone 104, and in response to the answer detection, generate and communicate to SSG 108 a TCAP Origination_Attempt_Requested notification message 710. In response to receiving message 710, SSG 108 generates and communicates to application server 106 a SIP Origination_Attempt_Requested notification message 712. Further, SSP 110 makes a call connection between phones 104 and 300. Application server 106 may report the call activity to call log server 112 for logging.

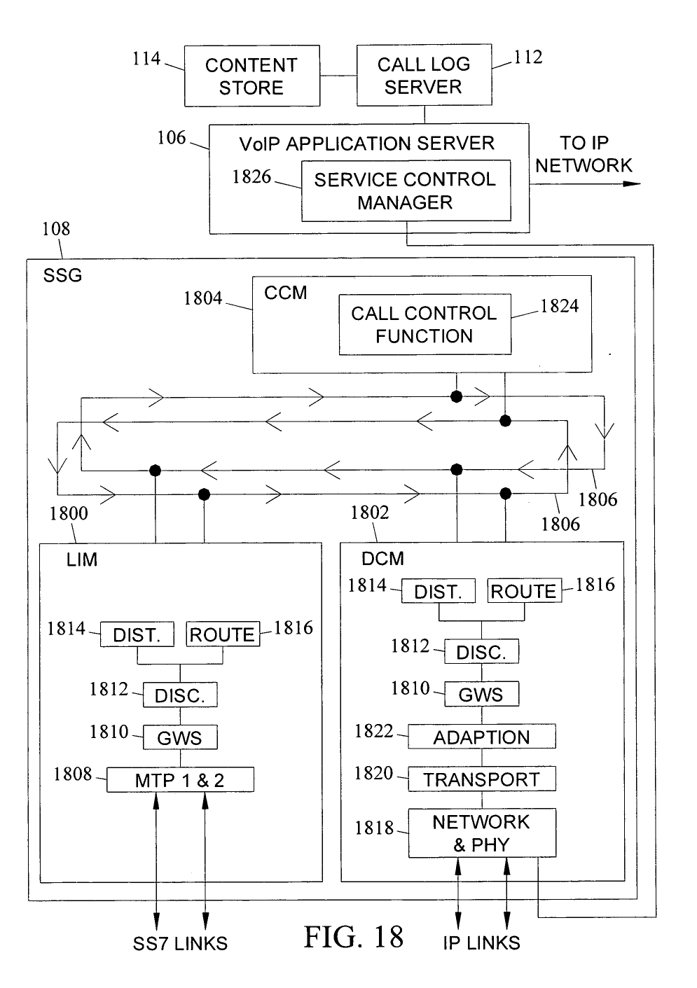

FIG. 18 is a block diagram illustrating exemplary internal architectures of application server 106 and SSG 108 according to an embodiment of the subject matter described herein. Referring to FIG. 18, routing node 108 includes a plurality of internal processing modules 1800, 1802, and 1804 connected to each other via a counter-rotating, dual-ring bus 1806. Processing modules 1800, 1802, and 1804 may each include an application processor and associated memory for implementing a telecommunications signaling function. In addition, each processing module may include a communications processor for communicating with other processing modules via bus 1806.

In the illustrated example, processing module 1800 comprises a link interface module (LIM) for interfacing with SS7 signaling links. LIM 1800 includes a message transfer part (MTP) level 1 and 2 function 1808, a gateway screening function 1810, a discrimination function 1812, a distribution function 1814, and a routing function 1816. MTP level 1 and 2 function 1808 performs MTP level 1 and 2 operations, such as error correction, error detection, and sequencing of SS7 signaling messages. Gateway screening function 1810 screens incoming SS7 signaling messages based on one or more parameters in the messages. Discrimination function 1812 determines whether a received SS7 signaling message should be distributed to another processing module within routing node 108 for further processing or whether the message should be routed over an outbound signaling link. Discrimination function 1812 forwards messages that are to be distributed for internal processing to distribution function 1814. Distribution function 1814 forwards the messages to the appropriate internal processing module. Routing function 1816 routes messages that are required to be routed based on MTP level 3 information in the messages. Signaling messages associated with call event triggers may be forwarded to call service module 1804. For example, all received ISUP messages may be forwarded to call control module 1804.

Processing module 1802 comprises data communications module (DCM) for sending and receiving signaling messages via IP signals links. DCM 1802 includes a network and physical layer function 1818, a transport layer function 1820, an adaptation layer function 1822, and layers 1810, 1812, 1814, and 1816 described with regard to LIM 1800. Network and physical layer function 1818 performs network and physical layer functions for sending and receiving messages over IP links. For example, function 1818 may implement IP over Ethernet. Transport layer function 1820 implements transport layer functions. For example, transport layer function 1820 may implement transmission control protocol (TCP), user datagram protocol (UDP), or stream control transmission protocol (SCTP). Adaptation layer function 1822 performs operations for adapting signaling messages, such as SS7 signaling messages, for transport over an IP network. Adaptation layer function 1822 may implement using any of the IETF adaptation layer protocols, such as M3UA, M2PA, SUA, TALI, or other suitable adaptation layer protocol. Functions 1810,1812,1814, and 1816 perform the operations described above for the corresponding numbered components of LIM 1800. Received signaling messages associated with call event triggers may be forwarded to call control module 1804.

Processing module 1804 is a call control module (CCM) for providing call control services. CCM 1804 may include a call control function 1824 for copying signaling messages associated with call event triggers and for forwarding the copies to CCM 1804. As stated above, SSG 108 may receive SIP messages from application server 106 that identify a call event trigger associated with subscriber 100. For example, a service control manager 1826 of application server 106 may generate and communicate to SSG 108 a SIP message that identifies a call event trigger that triggers on detection of an incoming call to a predetermined directory number of a phone. The phone may be associated with a subscriber to a circuit switched network. DCM 1802 may receive the SIP message, determine that the SIP message is associated with call event triggers, and forward a copy of the SIP message to CCM 1804. In response to receiving the copy of the SIP message, CCM 1804 may generate an SS7 message identifying the call event trigger and the subscriber, and forward the SS7 message to LIM 1800 for routing to a circuit switched network node. The circuit switched network node may set the call event trigger for detecting an incoming call to a predetermined directory number of a phone.

On call event triggering at the circuit switched network node, the network node may generate and communicate to SSG 108 an SS7 message indicating triggering of the call event corresponding to the call event trigger. LIM 1800 may receive the SS7 message, determine that the SS7 message is associated with call event triggers, and forward a copy of the SS7 message to CCM 1804. In response to receiving the copy of the SS7 message, CCM 1804 may generate a SIP message indicating triggering of the call event corresponding to the call event trigger, and forward the SIP message to DCM 1802 for routing to application server 106. Service control manager 1826 may examine SIP message and determine a call control function based on the call event triggering. In one example, the call event triggering can be reported to subscriber 100 at computer 102. In this example, subscriber 100 may use computer 102 to specify a call control function for application server 106. In another example, the call control function may be stored at application server 106 for implementation on the call event triggering. The call control function may be, for example, redirecting the incoming call to the directory number to another directory number. Service control manager 1826 may generate a SIP message specifying the call control function and route the SIP message to SSG 108.

DCM 1802 may receive the SIP message specifying the call control function, determine that the SIP message is associated with call event triggering, and forward a copy of the SIP message to CCM 1804. In response to receiving the copy, CCM 1804 may generate an SS7 message specifying the call control function and forward the SS7 message to LIM 1800 for routing to the circuit switched network node. The circuit switched network node may implement the call control function specified in the SS7 message. For example, the call control function may redirect the incoming call to the directory number specified in the SS7 message.

Application server 106 may communicate information to call log server 112 regarding the call event triggering. Call log server 112 and content store 114 may generate and store a call log record including information about the call event triggering. Further, call log server 112 may generate a message for notifying a subscriber of call event triggering. The message may be communicated to the subscriber via an IP network. For example, the message may be communicated to the subscriber's web-enabled computer. The message may be used by the computer for displaying information notifying the subscriber of call event triggering.

A processing module having the functionality of a call control function and a service control manager may be implemented entirely within SSG 108. Further, such a processing module may be implemented in any suitable network component such as a network routing node or an application server. Exemplary network routing nodes include a signal transfer point, an SS7/IP gateway, an SS7/SIP gateway, and a SIP router. Exemplary signaling messages include SS7 ISDN user part messages and SIP messages. A processing module including the above described functions may reside within a network routing node, on an adjunct processing platform that is in communication with the routing node, or elsewhere in a communications network.

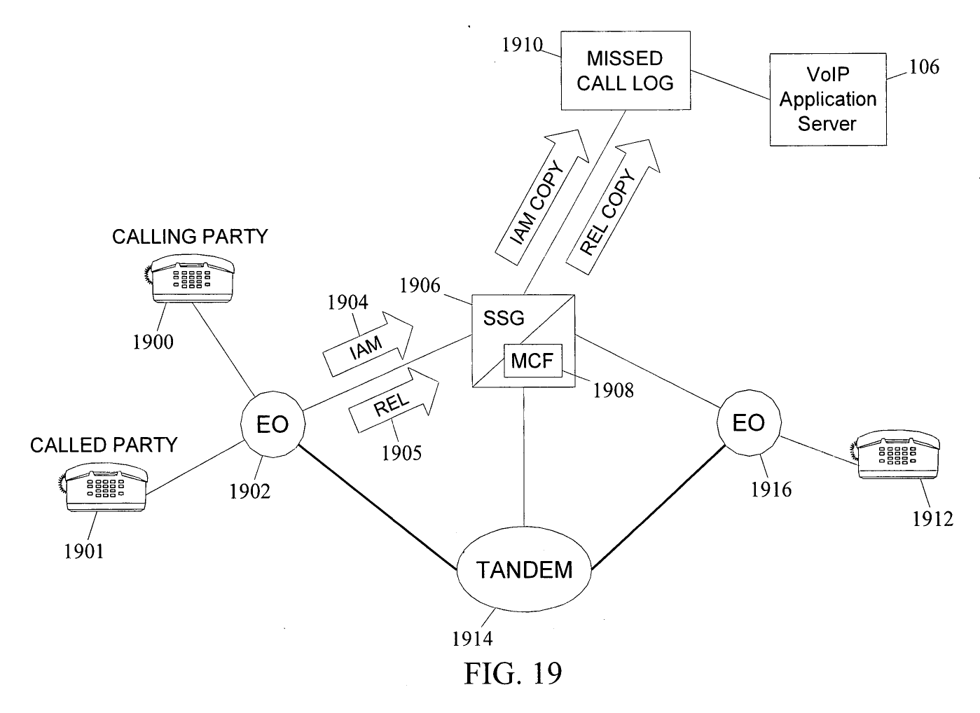

According to another aspect of the subject matter described herein, missed calls may be detected and subscribers may be presented with options, such as click-to-dial for calling a directory number associated with a missed call. FIG. 19 illustrates a missed call scenario in accordance with an embodiment of the subject matter described herein. Referring to FIG. 19, a calling party at a PSTN phone 1900 may dial a directory number for calling a phone 1901 associated with a subscriber. The call to phone 1901 may be missed. The missed call may be detected by missed call function 1910 based on the presence of an ISUP IAM message 1904 relating to a call followed by an ISUP release 1905 message relating to the call without receiving an intervening ISUP answer message. Missed call function 1908 may store notification of the missed call in call log server 1910. Call log server 1910 may deliver notification bf the missed call to IP application server 106. IP application server 106 may allow the subscriber to initiate a call with a directory number associated with the missed call, for example, using the click-to-call feature described herein. For example, using the click-to-call feature, the subscriber may initiate a call between a phone, such as a PSTN phone at the subscriber's office, and the phone from which the missed call was dialed, even if the missed call was to another phone, such as the subscriber's home phone. In the example illustrated in FIG. 19, the subscriber may set up a call between PSTN phone 1912 served by end office 1916 and phone 1900 served by end office 1902.

According to one embodiment, a VoIP application server function may store a call control function for use in providing a circuit switched network node with information for responding to a call event trigger. For example, a circuit switched network node may receive a request by a calling party to communicate with a called party. In this example, the VoIP application server function may be notified of the request and, in response to the notification, perform a call control function for generating a response message. The circuit switched network node may use information in the response message for call processing. The call control function may be performed when it is determined that the call involves a subscriber to a circuit switched network.

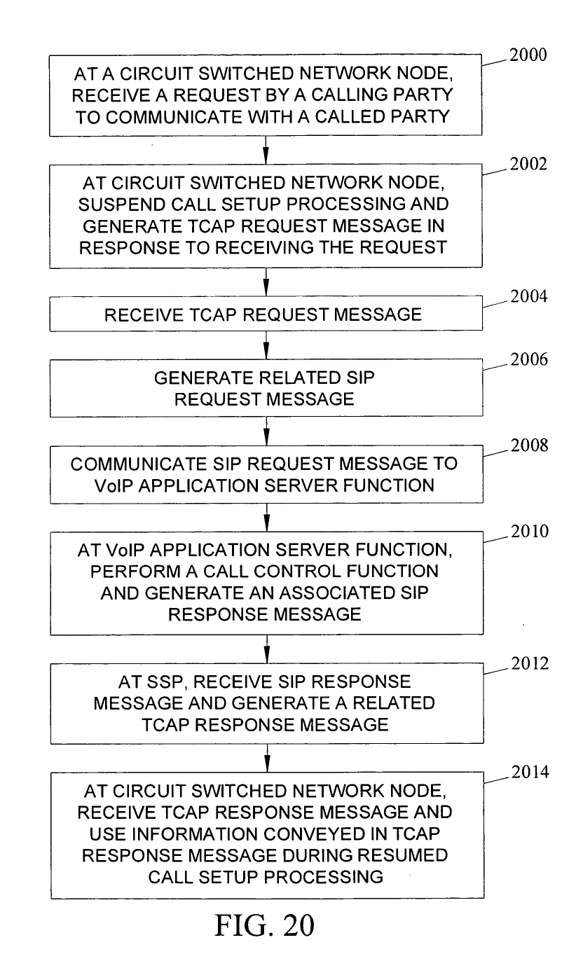

FIG. 20 is a flow chart of an exemplary process by which a VoIP application server may provide a circuit switched network node with information for responding to a call event trigger according to an embodiment of the subject matter described herein. Referring to FIGS. 1 and 20, in block 2000, SSP 110 may receive a request by phone 300 of a calling party to communicate with phone 104 associated with subscriber 100. In response to receiving the request, SSP switch 110 may suspend call setup processing and generate a TCAP request message for routing to SSG 108 (block 2002). For example, the call setup processing and message generation may be implemented in response to triggering of a call event trigger associated with subscriber 100. The TCAP request message may include an identifier for subscriber 100 and indicate that a call is being received from the calling party.

In block 2004, SSG 108 may receive the TCAP request message. In response to receiving the TCAP request message, SSG 108 may generate a related SIP request message (block 2006). The SIP request message may include an identifier for subscriber 100 and indicate that a call is being received from the calling party. The SIP request message may be communicated to a VoIP application server function of VoIP application server 106 (block 2008). The VoIP application server function may perform a call control function and generate an associated SIP response message which is routed to SSG 108 (block 2010).

SSG 108 may receive the SIP response message and generate a related TCAP response message, which is routed to SSP switch 110 (block 2012). SSP switch 110 may receive the TCAP response message and use information conveyed in the TCAP response message during resumed call setup processing (block 2014). SSP switch 110 may resume the call setup processing based on the information in the TCAP response message. For example, the information may indicate to redirect the call to a predetermined directory number or voicemail. Based on the information, SSP switch 110 may redirect the call to the predetermined number or voicemail.

The call activity may be stored in a call log record at call log server 112 and content store 114. Further, computer 102 may be provided with information related to the call activity for display to subscriber 100.

Messages communicated in a communication session between an SSP, an SSG, and an application server may be malformed. For example, TCAP messages received at an SSG may include a malformed TCAP component part or a malformed TCAP transaction portion. In one example, protocol errors may occur in message formation or exchange. The communication session may be terminated or otherwise resolved (e.g., a message component could not be decoded or validated) in response to detecting a malformed message. Further, a communication session may be terminated when a message is not deliverable. Further, for example, a timeout may be set for terminating a communication session when a response message is not received within a period for timeout.

### Specifying PSTN Call Control Events Using Signals

As stated above, the subject matter described herein allows a subscriber to dynamically control PSTN events using signaling. In one exemplary implementation, the events may be communicated to PSTN network elements using signals in addition to SPIRITS events. As used herein, a signal is a parameter that may be included in a SIP message that specifies a call control action to be performed by a PSTN network element. For example, a signal may be communicated from voice over IP application server 106 illustrated in FIG. 1 to SSG 108 in a SIP message. SSG 108 may translate the signal to a corresponding AIN control parameter to be included in a TCAP message and sent to SSP 110. Exemplary signals that may be included in SIP messages originated by voice over IP application 106 are provided below:
Continue SPIRITS mnemonic: CON
Mandatory parameters in SUBSCRIBE:: . . . (No parameter)
Send Notification
SPIRITS mnemonic: SN
Mandatory parameter in SUBSCRIBE: Echo Data
Forward Call
SPIRITS mnemonic: FWDC
Mandatory parameters in Subscribe: Called party Number, Calling Party
Number
Offer Call
SPIRITS mnemonic: OFFC
Mandatory parameters in Subscribe: Calling Party Number
Create Call
SPIRITS mnemonic: CRC
Mandatory parameters in Subscribe: Calling Party Number, Called Party
Number
Termination Attempt
SPIRITS mnemonic: TAT
Conditional parameters in Notify: Calling Party Number, Screening(O),
Presentation(O), CalledPartyNumber(O), OriginalCalledPartylD(O),
RedirectingPartylD(O), Redirectionlnformation(O)
Termination Notification
SPIRITS mnemonic: STN
Conditional parameters in Notify: Echo Data, TerminationIndicator,
ConnectTime(O) and BusyCause(O)
Call Error
SPIRITS mnemonic: CR
Mandatory parameter in NOTIFY: CallErrorCause
   In the above-listed signals, the continue signal is a mandatory parameter in a SIP subscribe message. The continue signal instructs the SSP to continue processing the call. The send notification signal is a mandatory parameter in a SIP subscribe message that instructs the SSP to Echo Data in any response messages that it sends to packet based communications nodes. The forward call signal instructs the SSP to forward a call to a predetermined number. It also specifies a calling party number. The offer call signal is a message that may be communicated to an IP application server in response to a terminal busy (T_BUSY) message. Further, regarding the offer call signal, the message requests that the IP application server offers the call to the called party (i.e., continue call processing and attempt to complete the call). The offer call signal may also include a display text parameter. In response to receiving the offer call signal, the IP application server may notify an associated subscriber of the terminal busy message. The create call signal allows a calling part to create a call between a calling part number and a called party number. The create call signal would be included in the above-referenced clip-to-dial seminars. A termination attempt signal can be used to specify that a subscriber desires to receive notification of termination attempts. A termination notification signal includes termination notification data sent in response to a termination attempt. The call error signal allows the PSTN network element to specify a reason for a call error.

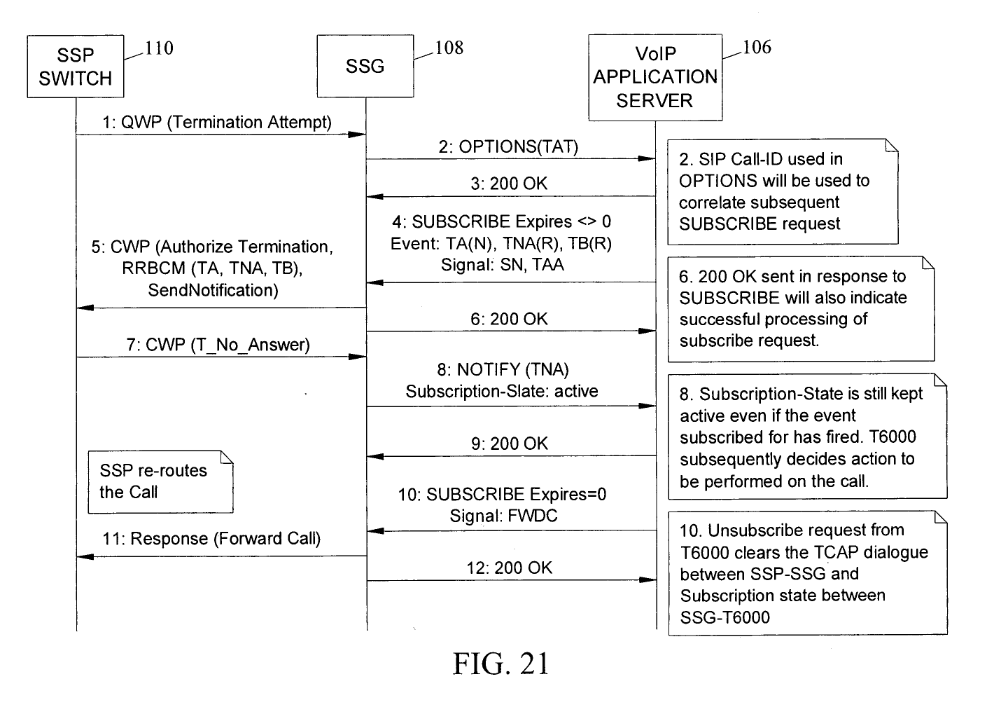

FIG. 21 is a message flow diagram illustrating an exemplary call redirect using signals according to an embodiment of the subject matter described herein. Referring to FIG. 21 in line 1 of the message flow diagram, SSP detects a call termination attempt and sends notification of the call termination attempt to SSG 108. In line 2, SSG 108 sends an options message with a terminating attempt signal to VoIP application server 106. VoIP application server 106 records the call ID associated with the termination attempt. In line 3, VoIP application server sends a 200 OK message to SSG 106 confirming the options message. In line 4, VoIP application server 106 sends a subscribe message to SSG 108. The subscribe message includes termination answer (TA), termination no answer (TNA), and termination busy (TB) events. The subscribe message also includes send notification (SN) and TAA signals. In line 5, SSG 108 sends an authorize termination message to SSP 110. The authorize termination message includes termination answer (TA), termination no answer (TNA), and termination busy (TB) events. The authorize termination message also includes send notification (SN).

In line 6 of the message flow diagram, SSG 108 responds with a 200 OK.

In line 7 of the message flow diagram, SSP 110 detects that a call to a directory number is unanswered and sends a termination no answer TCAP message to SSG 108. In line 8, SSG 108 sends notification of the termination no answer event to VoIP application server 106. In line 9, VoIP application server 106 responds to the notify message with a 200 OK message.

In line 10, VoIP application server 106 sends a subscribe message with a signal indicating that the call should be forwarded to a directory number, such as a number selected on the fly by a subscriber. In line 11, SSG 108 sends a TCAP message with a forward call instructions to SSP 110. In response to the TCAP message, SSP 110 forwards the call to the destination specified by the subscriber. In line 12, SSG 108 sends a 200 OK message to VoIP application server 106 confirming the subscribe message. Thus, using the steps illustrated in FIG. 21 and the signal specified above, a subscriber can dynamically change the behavior of a PSTN network element during the progress of a call.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for controlling a PSTN call from an IP network element using signaling, the method comprising:
at a session initiation protocol (SIP)-signaling system 7 (SS7) gateway:
(a) receiving a first SIP message from an Internet protocol (IP) application server, the first SIP message identifying a PSTN call event trigger;
(b) in response to receiving the first SIP message, generating a first SS7 message identifying the PSTN call event trigger and the subscriber, and routing the first SS7 message to a circuit-switched network node;
(c) receiving a second SS7 message from the circuit-switched network node, the second SS7 message indicating triggering of the PSTN call event corresponding to the trigger;
(d) in response to receiving the second SS7 message, generating a second SIP message indicating triggering of the PSTN call event and routing the second SIP message to the IP application server; and
(e) generating a third SIP message in response to the second SIP message, the third SIP message specifying a PSTN call control function for controlling the circuit-switched network node to implement the PSTN call control function.

2. The method of claim 1 wherein receiving a first SIP message from an IP application server includes receiving the first SIP message from a Voice over IP (VOIP) application server.

3. The method of claim 1 wherein the PSTN call event associated with the call event trigger is selected from the group consisting of a termination attempt, off-hook delay, answer, busy, no answer, and call termination.

4. The method of claim 1 wherein routing the first SS7 message to a circuit-switched network node includes routing the first SS7 message to a device selected from the group consisting of an end office and a service switching point (SSP).

5. The method of claim 1 wherein receiving a first SIP message identifying a PSTN call event trigger includes receiving the first SIP message identifying a call to a phone associated with the subscriber and wherein generating a third SIP message specifying a PSTN call control function includes generating a third SIP message specifying that the call be redirected to a predetermined directory number associated with the subscriber.

6. The method of claim 5 comprising, at the IP application server, indicating the call to the phone associated with the subscriber to a computer associated with the subscriber.

7. The method of claim 6 comprising, at the computer associated with the subscriber, displaying a notification of the call to the phone associated with the subscriber.

8. The method of claim 6 comprising, at the computer associated with the subscriber, receiving input for redirecting the call to the predetermined directory number associated with the subscriber.

9. The method of claim 5 comprising receiving input from the subscriber for dynamically redirecting the call to another phone associated with the subscriber, wherein generating the third SIP message includes specifying the redirection instructions in the third SIP message and wherein the method further comprises generating a third SS7 message based on the input, the third SS7 message specifying that the call be redirected to the directory number dynamically selected by the subscriber, and routing the third SS7 message to the circuit-switched network node.

10. The method of claim 9 comprising, at the circuit switched network node, setting up redirection of the call to the directory number dynamically selected by the subscriber.

11. The method of claim 10 wherein triggering of the call event corresponding to the trigger and setting up redirection of the call to the predetermined directory number occur in real-time.

12. The method of claim 1 wherein receiving a first SIP message identifying a call event trigger includes receiving the first SIP message identifying a call to a phone associated with the subscriber and wherein generating a third SIP message specifying a PSTN call control function includes generating a third SIP message specifying that the call be redirected to voicemail associated with the subscriber.

13. The method of claim 12 generating a third SS7 message based on the third SIP message, the third SIP message specifying that the call be redirected to the voicemail associated with the subscriber, and routing the third SS7 message to the circuit-switched network node.

14. The method of claim 13 comprising, at the circuit-switched network node, setting up redirection of the call to the voicemail associated with the subscriber.

15. The method of claim 1 wherein receiving a first SIP message identifying a PSTN call event trigger includes receiving the first SIP message identifying a call to a phone associated with the subscriber and wherein generating a third SIP message specifying a PSTN call control function includes one of generating a third SIP message specifying that the call continue, generating a third SIP message specifying answering of the call, receiving a third SIP message specifying routing the call to an interactive voice response resource, generating a third SIP message specifying that the phone to the subscriber is busy, and generating a third SIP message specifying that the call be disconnected.

16. The method of claim 1 comprising, at the IP application server, indicating triggering of the call event to a computer associated with the subscriber.

17. The method of claim 16 comprising, at the computer associated with the subscriber, displaying a notification of the call event.

18. The method of claim 1 comprising generating a third SS7 message in response to the third SIP message, the third SS7 message specifying the PSTN call control function and routing the third SS7 message to the circuit switch network node.

19. The method of claim 1 comprising, at the circuit switched network node, performing the PSTN call control function.

20. The method of claim 1 comprising generating a log record of triggering of the call event.

21. The method of claim 20 comprising displaying the log record at a computer accessible by the subscriber.

22. The method of claim 20 wherein generating a log record of triggering of the call event includes generating a log record including information selected from the group consisting of a directory number associated with the call event and a time of occurrence of the call event.

23. The method of claim 22 comprising generating a log record including a directory number associated with the subscriber for correlating the second SIP message to the subscriber.

24. The method of claim 22 comprising associating with the log record at least one of reachability information and presence information associated with the directory number.

25. The method of claim 1 comprising setting expiration of the PSTN call event trigger to infinite.

26. A method for providing packet network-based communication services to a circuit switched network subscriber, the method comprising:
(a) receiving a first SIP message from an Internet protocol (IP) application server, the first SIP message specifying to establish a call between phones, wherein at least one of the phones is associated with a subscriber to a circuit switched network; and
(b) in response to receiving the first SIP message, generating a first SS7 message specifying that the call be established between the phones, and routing the first SS7 message to a circuit switched network node.

27. The method of claim 26 comprising, at the IP application server, receiving a messaging specifying that the call be established between the phones from a computer associated with the subscriber.

28. The method of claim 27 wherein, at the computer associated with the subscriber, receiving input specifying that the call be established between the phones.

29. The method of claim 26 comprising generating a log record of establishing the call between the phones.

30. The method of claim 26 comprising, at the circuit switched network node, establishing the call between the phones.

31. A method for providing packet network-based communication services to circuit switched network subscribers, the method comprising:
(a) at circuit switched network node, receiving a request by a calling party to communicate with a called party;
(b) in response to receiving the request,
(i) suspending call setup processing;
(ii) generating a TCAP request message which is routed to a SIP-SS7 gateway;
(c) receiving the TCAP request message at the SIP-SS7 gateway and generating a related SIP request message;
(d) communicating the SIP request message to a voice over Internet protocol (VoIP) application server function;
(e) at the VoIP application server function, performing a call control function and generating an associated SIP response message which is routed to the SIP-SS7 gateway;
(f) at the SIP-SS7 gateway, receiving the SIP response message and generating a related TCAP response message, which is routed to the circuit switched network node; and
(g) receiving the TCAP response message at the circuit switched network node and using information conveyed in the TCAP response message during resumed call setup processing.

32. The method of claim 31 wherein the circuit switched network node is a network device selected from the group consisting of an end office and a service switching point (SSP).

33. The method of claim 32 wherein receiving a request by a calling party to communicate with a called party includes receiving a request by the calling party to communicate with a phone associated with a circuit switched network subscriber.

34. The method of claim 32 comprising, at the circuit switched network node, resuming call setup processing based on the information conveyed in the TCAP response message.

35. The method of claim 35 wherein resuming call setup processing based on the information conveyed in the TCAP response message includes redirecting the call to a predetermined number.

36. The method of claim 35 wherein resuming call setup processing based on the information conveyed in the TCAP response message includes redirecting the call to voicemail.

37. The method of claim 31 comprising storing information associated with the call in a call log record.

38. The method of claim 31 comprising displaying information associated with the call to a computer accessible by a circuit switched network subscriber.

39. A method for controlling a PSTN network element to dynamically implement a call control function using signals, the method comprising:
(a) receiving notification of a termination attempt to a PSTN phone;
(b) in response to receiving the notification, dynamically specifying a directory number to which a call associated with the termination attempt is to be rerouted;
(c) formulating a SIP message including, as a signal in the SIP message, instructions for dynamically redirecting the call to the directory number; and
(d) forwarding the SIP message including the signal to a network element for communicating the redirection instructions to a PSTN network element.

40. A method for dynamically setting advanced intelligent network (AIN) triggers in a circuit-switched network node from an IP network element using signaling, the method comprising:
at an IP network element:
(a) communicating a first SIP message to a session initiation protocol (SIP)-signaling system 7 (SS7) gateway (SSG) for setting a PSTN call event trigger;
(b) at the SSG; generating an SS7 message for setting the PSTN call event trigger and forwarding the SS7 message to a PSTN node; and
(c) at the PSTN node, dynamically arming the trigger in response to the SS7 message.

41. A method for subscribing to a PSTN event from an IP node, the method comprising:
(a) generating a SIP subscribe message for subscribing to receive notification of a PSTN event and forwarding the SIP subscribe message to a SIP-SS7 gateway (SSG);
(b) at the SSG, formulating and sending an SS7 message to a PSTN node for subscribing to receive notification of the event;
(c) at the SSG, receiving a TCAP response message confirming subscription to the notification;
(d) in response to the SIP subscribe message, communicating from the SSG to the IP application server, a single SIP notify message confirming receipt of the subscribe message and the arming of the subscription by the PSTN node.

42. The method of claim 41 wherein the subscribe message includes an expire field having a finite value and wherein the SSG is adapted to maintain the subscription until being notified by the IP application server to discontinue the subscription.

43. A method for pass-through notification of PSTN events to an IP application server, the method comprising:
(a) at an IP application server, generation a SIP options message for subscribing to a PSTN event;
(b) forwarding the SIP options message to a SIP-SS7 gateway;
(c) at the SSG, generation and forwarding an SS7 message for subscribing to the PSTN event to an SS7 node; and
(d) at the SSG. receiving notification of the event, and forwarding notification of the event to the IP application server in a pass-through manner.

44. The method of claim 43 wherein forwarding notification of the event to the IP application server in a pass-through manner includes forwarding the notification without accessing a database containing event triggering information.

45. A method for detecting and providing notification of a missed call using an IP application server, the method comprising:
(a) detecting the presence of a missed call involving a PSTN phone based on the presence of an ISUP IAM message followed by an ISUP release message without an intervening ISUP answer message; and
(b) delivering notification of the missed call to a subscriber terminal using an IP application server.

46. The method of claim 45 comprising, using the application server, presenting the subscriber with a click-to-dial option for initiating a call between a phone selected by the subscriber and a phone associated with a calling party of the missed call.

47. The method of claim 46 wherein the phone selected by the subscriber is different from a called phone associated with the missed call.

48. A system for controlling a PSTN call from an IP network element using signaling, the system comprising:
a session initiation protocol (SIP)-signaling system 7 (SS7) gateway configured to:
(a) receive a first SIP message from an Internet protocol (IP) application server, the first SIP message identifying a call event trigger associated with a subscriber to a circuit-switched network;
(b) generate a first SS7 message identifying the call event trigger and the subscriber, and routing the first SS7 message to a circuit switched network node in response to receiving the first SIP message;
(c) receive a second SS7 message from the circuit switched network node, the second SS7 message indicating triggering of the call event corresponding to the trigger;
(d) generate a second SIP message indicating triggering of the call event and route the second SIP message to the IP application server in response to receiving the second SS7 message; and
(e) receive a third SIP message in response to the second SIP message, the third SIP message specifying a PSTN call control function for controlling the circuit-switched network node to implement the PSTN call control function.

49. The system of claim 48 wherein the SIP-SS7 gateway is configured to receive the first SIP message from a Voice over IP (VOIP) application server.

50. The system of claim 48 wherein the call event associated with the call event trigger is selected from the call events consisting of a termination attempt, off-hook delay, answer, busy, no answer, and call termination.

51. The system of claim 48 wherein the SIP-SS7 gateway is configured to route the first SS7 message to a circuit switched network node is a network device selected from the group consisting of an end office and a service switching point (SSP).

52. The system of claim 48 wherein the SIP-SS7 gateway is configured to receive the first SIP message identifying a call to a phone associated with the subscriber; and wherein the SIP-SS7 gateway is configured to receive a third SIP message specifying that the call be redirected to a predetermined directory number associated with the subscriber.

53. The system of claim 48 wherein the IP application server is configured to indicate the call to the phone associated with the subscriber to a computer associated with the subscriber.

54. The system of claim 53 wherein the computer associated with the subscriber is configured to display a notification of the call to the phone associated with the subscriber.

55. The system of claim 54 wherein the computer associated with the subscriber is configured to receive input for redirecting the call to the predetermined directory number associated with the subscriber.

56. The system of claim 55 wherein the SIP-SS7 gateway is configured to generate a third SS7 message specifying that the call be redirected to a predetermined directory number associated with the subscriber, and route the third SS7 message to the circuit switched network node in response to receiving the third SIP message.

57. The system of claim 56 wherein the circuit switched network node is configured to set up redirection of the call to the predetermined directory number associated with the subscriber.

58. The system of claim 57 wherein the circuit switched network node is configured to set up redirection of the call to the predetermined directory number in real-time with the call event triggering.

59. The system of claim 48 wherein the SIP-SS7 gateway is configured to receive the first SIP message identifying a call to a phone associated with the subscriber; and wherein the SIP-SS7 gateway is configured to receive a third SIP message specifying that the call be redirected to voicemail associated with the subscriber.

60. The system of claim 59 wherein the SIP-SS7 gateway is configured to receive generate a third SS7 message specifying that the call be redirected to the voicemail associated with the subscriber, and route the third SS7 message to the circuit switched network node in response to receiving the third SIP message.

61. The system of claim 60 wherein the circuit switched network node is configured to set up redirection of the call to the voicemail associated with the subscriber.

62. The system of claim 48 wherein the SIP-SS7 gateway is configured to receive the first SIP message identifying a call to a phone associated with the subscriber; and wherein the SIP-SS7 gateway is configured to one of receive a third SIP message specifying that the call continue, receive a third SIP message specifying answering of the call, receive a third SIP message specifying routing the call to an interactive voice response resource, receive a third SIP message specifying that the phone to the subscriber is busy, and receive a third SIP message specifying that the call be disconnected.

63. The system of claim 48 wherein the IP application server is configured to indicate triggering of the call event to a computer associated with the subscriber.

64. The system of claim 63 wherein the computer associated with the subscriber is configured to display a notification of the call event.

65. The system of claim 48 the SIP-SS7 gateway is configured to generate a third SS7 message specifying the PSTN call control function and to route the third SS7 message to the circuit switch network node in response to receiving the third SIP message,.

66. The system of claim 48 wherein the circuit switched network node is configured to perform the PSTN call control function.

67. The system of claim 48 comprising a call log server configured to generate a log record of triggering of the call event.

68. The system of claim 67 comprising a computer accessible by the subscriber and configured to display the log record.

69. The system of claim 67 wherein the call log record includes information selected from the group consisting of a directory number associated with the call event and a time of occurrence of the call event.

70. The system of claim 69 wherein the SIP-SS7 gateway is configured to associate with the log record at least one of reachability information and presence information associated with the directory number.

71. A system for providing packet network-based communication services to
a circuit switched network subscriber, the system comprising:
a session initiation protocol (SIP)-signaling system 7 (SS7) gateway configured to:
(a) receive a first SIP message from an Internet protocol (IP) application server, the first SIP message specifying to establish a call between phones, wherein at least one of the phones is associated with a subscriber to a circuit switched network; and
(b) generate a first SS7 message specifying that the call be established between the phones, and route the first SS7 message to a circuit switched network node in response to receiving the first SIP message.

72. The system of claim 71 wherein the IP application server is configured to receive a messaging specifying that the call be established between the phones from a computer associated with the subscriber.

73. The system of claim 71 wherein the computer associated with the subscriber is configured to receive input specifying that the call be established between the phones.

74. The system of claim 71 wherein the SIP-SS7 gateway is configured to generate a log record of establishing the call between the phones.

75. The system of claim 71 wherein the circuit switched network node is configured to establish the call between the phones.

76. A system for providing packet network-based communication services to circuit switched network subscribers, the system comprising:
(a) a circuit switched network node operable to provide circuit switched telecommunication service to a subscriber, wherein the circuit switched network node is further operable to:
(i) receive a request by a calling party to communicate with a called party;
(ii) suspend call setup processing associated with the communication request;
(iii) generate a TCAP request message;
(iv) receive a TCAP response message; and
(v) resume call setup processing using information conveyed in the TCAP response message;
(b) a SIP-SS7 gateway function operable to:
(i) receive the TCAP request message and generate a related SIP request message; and
(ii) receive a SIP response message and generate a related TCAP response message; and
(c) a VoIP application server operable to:
(i) receive the SIP request message;
(ii) perform a call control function; and
(iii) generate the SIP response message.

77. The system of claim 76 wherein the circuit switched network node is a network device selected from the group consisting of an end office and a service switching point (SSP).

78. The system of claim 76 wherein the circuit switched network node is configured to receive a request by the calling party to communicate with a phone associated with a circuit switched network subscriber.

79. The system of claim 76 wherein the circuit switched network node is configured to resume call setup processing based on the information conveyed in the TCAP response message.

80. The system of claim 79 wherein the circuit switched network node is configured to redirect the call to a predetermined number.

81. The system of claim 79 wherein the circuit switched network node is configured to redirect the call to voicemail.

82. The system of claim 76 comprising a call log server configured to store information associated with the call in a call log record.

83. The system of claim 76 comprising a computer accessible by a circuit switched network subscriber and configured to display information associated with the call.

84. A system for controlling a PSTN call from an IP network element using signaling, the system comprising:
(a) an IP network element for generating and forwarding a first SIP message for setting a PSTN call event trigger;
(b) a session initiation protocol (SIP)-signaling system 7 (SS7) gateway (SSG) for receiving the first SIP message, for generating an SS7 message for setting the PSTN call event trigger and forwarding the SS7 message; and
(c) a PSTN node for receiving the SS7 message and for dynamically arming the trigger in response to the SS7 message.

85. A computer program product comprising computer executable instructions embodied in a computer readable medium for performing steps comprising:
at a session initiation protocol (SIP)-signaling system 7 (SS7) gateway:
(a) receiving a first SIP message from an Internet protocol (IP) application server, the first SIP message identifying a PSTN call event trigger;
(b) in response to receiving the first SIP message, generating a first SS7 message identifying the PSTN call event trigger and the subscriber, and routing the first SS7 message to a circuit-switched network node;
(c) receiving a second SS7 message from the circuit-switched network node, the second SS7 message indicating triggering of the PSTN call event corresponding to the trigger;
(d) in response to receiving the second SS7 message, generating a second SIP message indicating triggering of the PSTN call event and routing the second SIP message to the IP application server; and
(e) generating a third SIP message in response to the second SIP message, the third SIP message specifying a PSTN call control function for controlling the circuit-switched network node to implement the PSTN call control function.

86. A computer program product comprising computer executable instructions embodied in a computer readable medium for performing steps comprising:
(a) receiving a first SIP message from an Internet protocol (IP) application server, the first SIP message specifying to establish a call between phones, wherein at least one of the phones is associated with a subscriber to a circuit switched network; and
(b) in response to receiving the first SIP message, generating a first SS7 message specifying that the call be established between the phones, and routing the first SS7 message to a circuit switched network node.

87. A computer program product comprising computer executable instructions embodied in a computer readable medium for performing steps comprising:
(a) at circuit switched network node, receiving a request by a calling party to communicate with a called party;
(b) in response to receiving the request,
(i) suspending call setup processing; and
(ii) generating a TCAP request message which is routed to a SIP-SS7 gateway;
(c) receiving the TCAP request message at the SIP-SS7 gateway and generating a related SIP request message;
(d) communicating the SIP request message to a voice over Internet protocol (VoIP) application server function;
(e) at the VoIP application server function, performing a call control function and generating an associated SIP response message which is routed to the SIP-SS7 gateway;
(f) at the SIP-SS7 gateway, receiving the SIP response message and generating a related TCAP response message, which is routed to the circuit switched network node; and
(g) receiving the TCAP response message at the circuit switched network node and using information conveyed in the TCAP response message during resumed call setup processing.
